(19) United States
(12) Patent Application Publication
(10) Pub. No.: US 2025/0048389 A1
(43) Pub. Date: Feb. 6, 2025

(54) PDCCH MONITORING ADAPTATION IN FULL-DUPLEX SYSTEMS

(71) Applicant: Samsung Electronics Co., Ltd., Suwon-si (KR)

(72) Inventors: Marian Rudolf, Longueuil (CA); Emad Nader Farag, Flanders, NJ (US); Aristides Papasakellariou, Houston, TX (US)

(21) Appl. No.: 18/778,291

(22) Filed: Jul. 19, 2024

Related U.S. Application Data
(60) Provisional application No. 63/530,205, filed on Aug. 1, 2023.

(51) Int. Cl. H04W 72/232; H04L 5/00; H04W 72/0446

(52) U.S. Cl. CPC H04W 72/232; H04L 5/0048; H04W 72/0446

(57) ABSTRACT

Apparatuses and methods for adaptation of monitoring for physical downlink control channels (PDCCHs) in full-duplex (FD) systems. A method for a user equipment (UE) to receive PDCCHs includes receiving first and second sets of parameters for reception of first and second PDCCHs associated with first and second subset of slots, respectively. The method further includes receiving a first PDCCH from the first PDCCHs that provides a downlink control information (DCI) format that includes a field indicating skipping receptions of the second PDCCHs and skipping, based on the field, receptions of the second PDCCHs in a slot from the second subset of slots at a first occasion that is after reception of the first PDCCH and before an end of a time duration. The second subset of slots includes time-domain resources indicated for simultaneous transmission and reception and the first subset of slots does not.

### CROSS-REFERENCE TO RELATED AND CLAIM OF PRIORITY

The present application claims priority under 35 U.S.C. § 119(e) to U.S. Provisional Patent Application No. 63/530,205 filed on Aug. 1, 2023, which is hereby incorporated by reference in its entirety.

### TECHNICAL FIELD

The present disclosure relates generally to wireless communication systems and, more specifically, the present disclosure is related to adaptation of monitoring for physical downlink control channels (PDCCHs) in full-duplex (FD) systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to PDCCH monitoring adaptation in FD systems.

In one embodiment, a method for a user equipment (UE) to receive PDCCHs is provided. The method includes receiving a first set of parameters for reception of first PDCCHs associated with a first subset of slots from a set of slots and a first transmission configuration indicator (TCI) state configuration on a cell and receiving a second set of parameters for reception of second PDCCHs associated with a second subset of slots from the set of slots and a second TCI state configuration on the cell. The method further includes receiving a first PDCCH from the first PDCCHs that provides a downlink control information (DCI) format that includes a field indicating skipping receptions of the second PDCCHs and skipping, based on the field, receptions of the second PDCCHs in a slot from the second subset of slots at a first occasion that is after reception of the first PDCCH and before an end of a time duration. The second subset of slots includes time-domain resources indicated for simultaneous transmission and reception on the cell and the first subset of slots does not.

In another embodiment, a UE is provided. The UE includes a transceiver configured to receive a first set of parameters for reception of first PDCCHs associated with a first subset of slots from a set of slots and a first TCI state configuration on a cell; receive a second set of parameters for reception of second PDCCHs associated with a second subset of slots from the set of slots and a second TCI state configuration on the cell; and receive a first PDCCH from the first PDCCHs that provides a DCI format that includes a field indicating skipping receptions of the second PDCCHs. The UE further includes a processor operably coupled to the transceiver. The processor is configured to determine to skip, based on the field, receptions of the second PDCCHs in a slot from the second subset of slots at a first occasion that is after reception of the first PDCCH and before an end of a time duration. The second subset of slots includes time-domain resources indicated for simultaneous transmission and reception on the cell and the first subset of slots does not.

In yet another embodiment, a base station (BS) is provided. The BS includes a processor and a transceiver operably coupled to the processor. The transceiver is configured to transmit a first set of parameters for reception of first PDCCHs associated with a first subset of slots from a set of slots and a first TCI state configuration on a cell; transmit a second set of parameters for reception of second PDCCHs associated with a second subset of slots from the set of slots and a second TCI state configuration on the cell; and transmit a first PDCCH from the first PDCCHs that provides a DCI format that includes a field indicating skipping receptions of the second PDCCHs in a slot from the second subset of slots at a first occasion that is after transmission of the first PDCCH and before an end of a time duration. The second subset of slots includes time-domain resources indicated for simultaneous transmission and reception on the cell and the first subset of slots does not.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example base station (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for physical downlink shared channel (PDSCH) in a subframe according to embodiments of the present disclosure;

FIG. 6 illustrates an example of a receiver structure for PDSCH in a subframe according to embodiments of the present disclosure;

FIG. 7 illustrates an example of a transmitter structure for physical uplink shared channel (PUSCH) in a subframe according to embodiments of the present disclosure;

FIG. 8 illustrates an example of a receiver structure for a PUSCH in a subframe according to embodiments of the present disclosure;

FIG. 9 illustrates an example of a transmitter structure for beamforming according to embodiments of the present disclosure;

FIG. 10 illustrates a timeline of an example time division duplexing (TDD) configuration according to embodiments of the present disclosure;

FIG. 11 illustrates timelines of example FD configurations according to embodiments of the present disclosure;

FIG. 12 illustrates an example of a transmitter structure for a PDCCH according to embodiments of the present disclosure;

FIG. 13 illustrates an example of a receiver structure for a PDCCH according to embodiments of the present disclosure;

FIG. 14 illustrates a flowchart of an example process of PDCCH skipping for subband full duplex (SBFD)/non-SBFD symbol types based on provided SBFD configuration(s) per TRP in a FD communication system according to embodiments of the present disclosure;

FIG. 15 illustrates a flowchart of an example process of PDCCH skipping for SBFD subband types based on provided SBFD configuration(s) per TRP in a FD communication system according to embodiments of the present disclosure;

FIG. 16 illustrates a flowchart of an example process of SSSG switching for SBFD/non-SBFD symbol types based on provided SBFD configuration(s) per TRP in a FD communication system according to embodiments of the present disclosure; and

FIG. 17 illustrates a flowchart of an example process of SSSG switching for SBFD subband types based on provided SBFD configuration(s) per TRP in a full-duplex communication system according to embodiments of the present disclosure.

### DETAILED DESCRIPTION

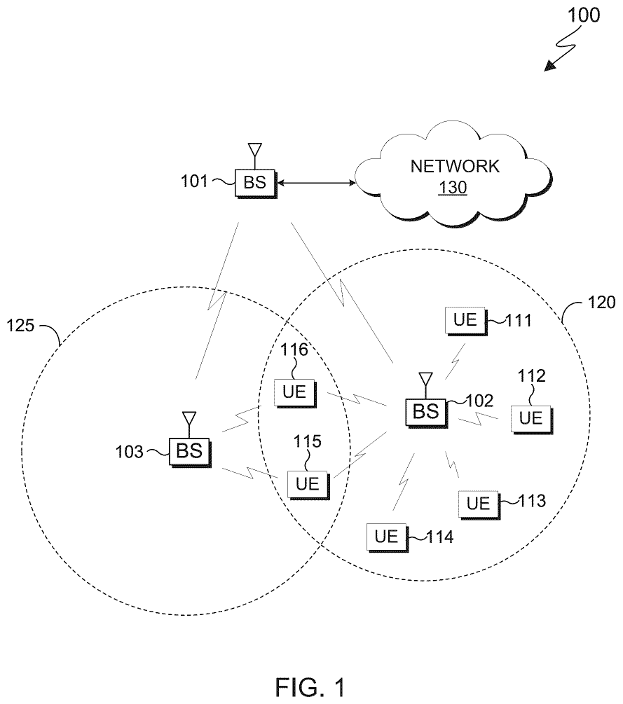

FIGS. 1-17 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1]3GPP TS 38.211 v17.5.0, “NR; Physical channels and modulation;” [2]3GPP TS 38.212 v17.5.0, “NR; Multiplexing and Channel coding;” [3]3GPP TS 38.213 v17.6.0, “NR; Physical Layer Procedures for Control;” [4]3GPP TS 38.214 v17.6.0, “NR; Physical Layer Procedures for Data;” [5]3GPP TS 38.321 v17.5.0, “NR; Medium Access Control (MAC) protocol specification;” [6]3GPP TS 38.331 v17.5.0, “NR; Radio Resource Control (RRC) Protocol Specification;” [7]3GPP TS 38.133 v17.10.0, “NR; Requirements for support of radio resource management;” [8]3GPP TS 38.300 v17.5.0, “NR; NR and NG-RAN Overall Description; Stage 2;” [9]3GPP TS 38.306 v17.5.0, “NR; User Equipment (UE) radio access capabilities;” and [10]3GPP TS 38.822 v17.1.0, “NR; User Equipment (UE) feature list.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for adaptation of physical downlink control channels (PDCCH) monitoring in full-duplex (FD) systems. In certain embodiments, one or more of the gNBs 101-103 include circuitry, programing, or a combination thereof to support PDCCH monitoring adaptation in FD systems.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

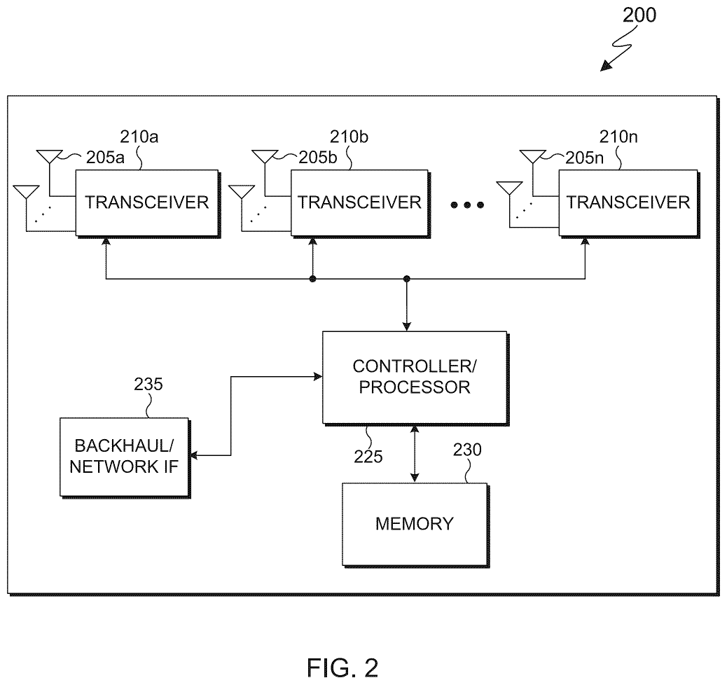

FIG. 2 illustrates an example TRP 200 according to embodiments of the present disclosure. For example, the TRP 200 any be a base station, such as gNB 101-103, or may be an NCR or smart repeater (SR), such as the relay node 104 in FIG. 1. The embodiment of the TRP 200 illustrated in FIG. 2 is for illustration only. However, TRPs come in a wide variety of configurations, and FIG. 2 does not limit the scope of this disclosure to any particular implementation of a TRP.

As shown in FIG. 2, the TRP 200 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs or gNBs in the network 100. In various embodiments, certain of the transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals. For example, in embodiments where the TRP is a repeater, one or more of the transceivers 210 may be used for an NCR-RU entity or NCR-Fwd entity as a DL connection for signaling over an access link with a UE and/or over a backhaul link with a gNB. In these examples, the associated one(s) of the transceivers 210 for the NCR-RU entity or NCR-Fwd entity may not covert the incoming RF signal to IF or a baseband signal but rather amplify the incoming RF signal and forward or relay the amplified signal, without any down conversion to IF or baseband. In another example, in embodiments where the TRP is a repeater, one or more of the transceivers 210 may be used for an NCR-MT entity as a DL or UL connection for control signaling over a control link (C-link) with a gNB.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the TRP 200. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for PDCCH monitoring adaptation in FD systems. Any of a wide variety of other functions could be supported in the TRP 200 by the controller/processor 225.

The controller/processor 225 is also capable of executing programs and other processes resident in the memory 230, such as processes to support PDCCH monitoring adaptation in FD systems. The controller/processor 225 can move data into or out of the memory 230 as required by an executing process.

The controller/processor 225 is also coupled to the backhaul or network interface 235. The backhaul or network interface 235 allows the TRP 200 to communicate with other devices or systems over a backhaul connection or over a network. The interface 235 could support communications over any suitable wired or wireless connection(s). For example, when the TRP 200 is implemented as part of a cellular communication system (such as one supporting 5G/NR, LTE, or LTE-A), the interface 235 could allow the TRP 200 to communicate with other gNBs over a wired or wireless backhaul connection, for example, using a transceiver, such as described above with regard to transceivers 210. For example, in embodiments where the TRP is a repeater, the interface 235 may be used for an NCR-RU or NCR-Fwd entity as a backhaul connection with a gNB over a backhaul link for control signaling and/or data to be transmitted to and/or received from a UE. When the TRP 200 is implemented as an access point, the interface 235 could allow the TRP 200 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

In various embodiments, the TRP 200 may be utilized as an NCR or SR. For example, the TRP 200 may communicate with a base station 102 via a wireless backhaul over interface 235 via a NCT-MT entity for control information and may communicate via transceivers 210 with the UE 116 to communicate data information via an NCR-Fwd entity as described in greater detail below.

Although FIG. 2 illustrates one example of TRP 200, various changes may be made to FIG. 2. For example, the TRP 200 could include any number of each component shown in FIG. 2. Also, various components in FIG. 2 could be combined, further subdivided, or omitted and additional components could be added according to particular needs.

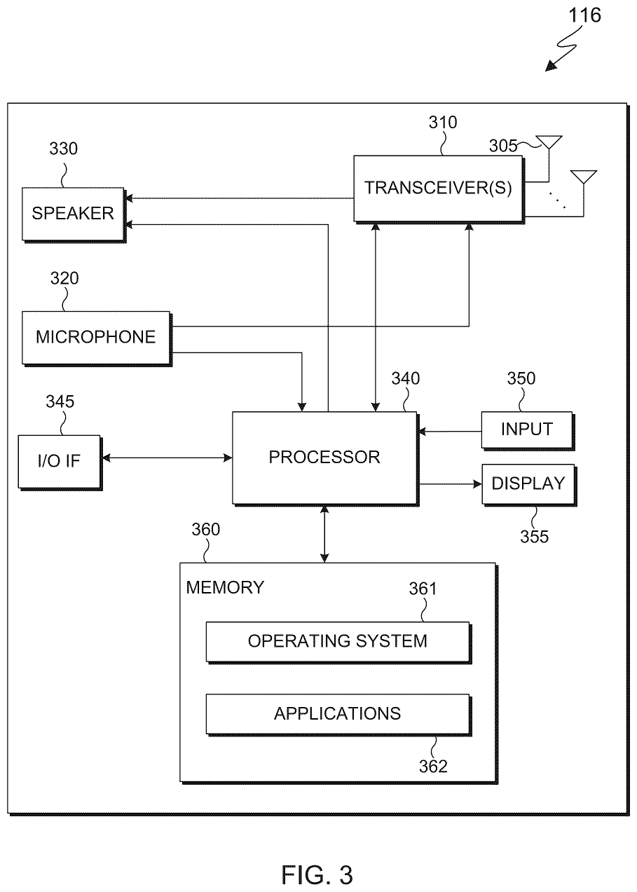

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the ULE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for PDCCH monitoring adaptation in FD systems as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

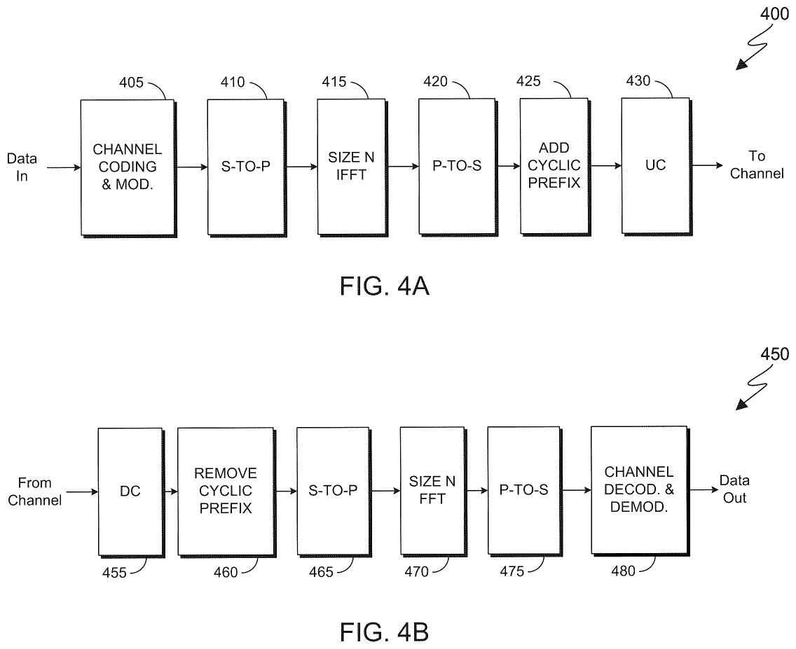

FIG. 4A and FIG. 4B illustrate an example of wireless transmit and receive paths 400 and 450, respectively, according to embodiments of the present disclosure. For example, a transmit path 400 may be described as being implemented in a gNB or TRP (such as gNB 102 or TRP 200), while a receive path 450 may be described as being implemented in a UE (such as UE 116). However, it will be understood that the receive path 450 can be implemented in a gNB or TRP and that the transmit path 400 can be implemented in a UE. In some embodiments, the transmit path 400 and/or the receive path 450 is configured for enabling PDCCH monitoring adaptation in FD systems as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 or the TRP 200 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the gNBs 101-103 or the TRP 200 and may implement a receive path 450 for receiving in the downlink from the gNBs 101-103 or the TRP 200.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

A communication system can include a downlink (DL) that refers to transmissions from a base station (such as the BS 102) or one or more transmission points to UEs (such as the UE 116) and an uplink (UL) that refers to transmissions from UEs (such as the UE 116) to a base station (such as the BS 102) or to one or more reception points.

A time unit for DL signaling or for UL signaling on a cell is referred to as a slot and can include one or more symbols. A symbol can also serve as an additional time unit. A frequency or bandwidth (BW) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A gNB transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with CRC scrambled by C-RNTI/CS-RNTI/MCS-C-RNTI as described in [2], are referred for brevity as a unicast DCI format. A DCI format scheduling PDSCH reception for multicast communication, such as a DCI format with CRC scrambled by G-RNTI/G-CS-RNTI as described in [2], are referred to as multicast DCI format. DCI formats providing various control information to at least a subset of UEs in a serving cell, such as DCI format 20 in [2], are referred to as group-common (GC) DCI formats.

A gNB (such as the BS 102) transmits one or more of multiple types of RS including channel state information RS (CSI-RS) and demodulation RS (DM-RS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources.

A UE (such as the UE 116) can determine CSI-RS transmission parameters through DL control signaling or higher layer signaling, such as radio resource control (RRC) signaling, from a gNB (such as the BS 102). Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In certain embodiments, UL signals also include data signals conveying information content, control signals conveying UL control information (UCI), DM-RS associated with data or UCI demodulation, sounding RS (SRS) enabling a gNB to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The gNB can configure the UE to transmit signals on a cell within an active UL bandwidth part (BWP) of the cell UL BW.

UCI includes HARQ acknowledgement (ACK) information, indicating correct or incorrect detection of data transport blocks (TBs) in a PDSCH, scheduling request (SR) indicating whether a UE has data in a buffer, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a gNB of a largest modulation and coding scheme (MCS) for the UE to detect a data TB with a predetermined block error rate (BLER), such as a 10% BLER (see NR specification), of a precoding matrix indicator (PMI) informing a gNB how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A gNB can use a DM-RS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are QCL with QCL type A, type D (when applicable) and average gain. The UE may further assume that no DM-RS collides with the SS/PBCH block.

A beam may be determined by a transmission configuration indication (TCI) state that establishes a quasi-co-location (QCL) relationship or a spatial relation between a source reference signal, e.g., a synchronization signal block (SS/PBCH Block or SSB) or channel state information reference signal (CSI-RS) and a target reference signal, or a spatial relationship information that establishes an association to a source reference signal, such as an SSB, CSI-RS, or sounding reference signal (SRS). In either case, the ID of the source reference signal can identify the beam.

The TCI state and/or the spatial relationship reference RS can determine a spatial Rx filter for reception of downlink channels or signals at the UE, or a spatial Tx filter for transmission of uplink channels or signals from the UE. The TCI state and/or the spatial relation reference RS can determine a spatial Tx filter for transmission of downlink channels or signals from the gNB, or a spatial Rx filter for reception of uplink channels or signals at the gNB.

A UE can be indicated a spatial setting for a PDCCH reception based on a configuration of a value for a transmission configuration indication state (TCI state) of a control resource set (CORESET) where the UE receives the PDCCH. The UE can be indicated a spatial setting for a PDSCH reception based on a configuration by higher layers or based on an indication by a DCI format scheduling the PDSCH reception of a value for a TCI state. The gNB can configure the UE to receive signals on a cell within a DL bandwidth part (BWP) of the cell DL BW.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

A quasi-co-location (QCL) relationship may be configured by the higher layer parameter qcl-Type1 for a first DL RS, and qcl-Type2 for a second DL RS (if configured). For the case of two DL RSs, the QCL types may not be the same, regardless of whether the references are to the same DL RS or different DL RSs. The quasi-co-location types corresponding to each DL RS can be given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

A reference RS may correspond to a set of characteristics of a DL beam or an UL Tx beam, such as a direction, a precoding/beamforming, a number of ports, and so on.

A UE can be provided through higher layer RRC signaling a set of TCI States with N elements. In one example, DL and joint TCI states are configured by higher layer parameter DLorJoint-TCIState, wherein, the number of DL and Joint TCI state is N_{DJ}. UL TCI states are configured by higher layer parameter UL-TCIState, wherein the number of UL TCI states is N_{U}. N=N_{DJ}+N_{U}. The DLorJoint-TCIState can include DL or Joint TCI states for a serving cell. The source RS of the TCI state may be associated with the serving cell, e.g., the PCI of the serving cell. Additionally, the DL or Joint TCI states can be associated with a cell having a PCI different from the PCI of the serving cell, e.g., the source RS of the TCI state is associated with a cell having a PCI different from the PCI of the serving cell. The UL-TCIState can include UL TCI states that belong to a serving cell, e.g., the source RS of the TCI state is associated with the serving cell (the PCI of the serving cell); additionally, the UL TCI states can be associated with a cell having a PCI different from the PCI of the serving cell, e.g., the source RS of the TCI state is associated with a cell having a PCI different from the PCI of the serving cell.

MAC CE signaling can include a subset of M (M≤N) TCI states or TCI state code points from the set of N TCI states, wherein a code point is signaled in the “transmission configuration indication” field of a DCI used for indication of the TCI state. A codepoint can include one TCI state, e.g., DL TCI state or UL TCI state or Joint (DL and UL) TCI state. Alternatively, a codepoint can include two TCI states, e.g., a DL TCI state and an UL TCI state. L1 control signaling, i.e., Downlink Control Information (DCI) can update the UE's TCI state, wherein the DCI includes a “transmission configuration indication” (beam indication) field, e.g., using m bits such that M≤2^{m}. The TCI state may correspond to a code point signaled by MAC CE. A DCI used for indication of the TCI state can be a DCI format 1_1 or DCI format 1_2 or DCI format 1_3 with a DL assignment for PDSCH receptions or without a DL assignment for PDSCH receptions.

The TCI states can be associated through a QCL relation with an SSB or a CSI-RS of serving cell, or an SSB or a CSI-RS associated with a PCI different from the PCI of the serving cell. The QCL relation with an SSB can be a direct QCL relation, wherein the source RS, e.g., for a QCL Type D relation or a spatial relation of the QCL state is the SSB. The QCL relation with an SSB can be an indirect QCL relation wherein the source RS, e.g., for a QCL Type D relation or a spatial relation can be a CSI-RS and the CSI-RS has the SSB as its source, e.g., for a QCL Type D relation or a spatial relation. The indirect QCL relation to an SSB can involve a QCL or spatial relation chain of more than one CSI-RS.

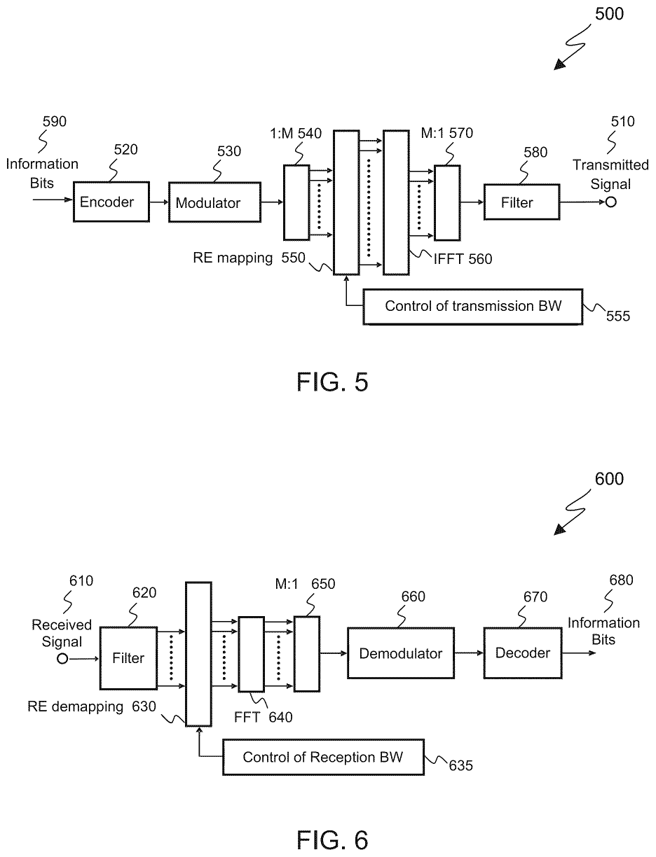

FIG. 5 illustrates an example of a transmitter structure 500 for PDSCH in a subframe according to embodiments of the present disclosure. For example, transmitter structure 500 can be implemented in gNB 102 of FIG. 1. This example is for illustration only and other embodiments can be used without departing from the scope of the present disclosure.

As illustrated in FIG. 5, information bits 510 are encoded by encoder 520, such as a turbo encoder, and modulated by modulator 530, for example using Quadrature Phase Shift Keying (QPSK) modulation. A Serial to Parallel (S/P) converter 540 generates M modulation symbols that are subsequently provided to a mapper 550 to be mapped to REs selected by a transmission BW selection unit 555 for an assigned PDSCH transmission BW, unit 560 applies an Inverse Fast Fourier Transform (IFFT), the output is then serialized by a Parallel to Serial (P/S) converter 570 to create a time domain signal, filtering is applied by filter 580, and a signal transmitted 590. Additional functionalities, such as data scrambling, cyclic prefix insertion, time windowing, interleaving, and others are well known in the art and are not shown for brevity.

FIG. 6 illustrates an example of a receiver structure 600 for PDSCH in a subframe according to embodiments of the present disclosure. For example, receiver structure 600 can be implemented by any of the UEs 111-116 of FIG. 1. This example is for illustration only and other embodiments can be used without departing from the scope of the present disclosure.

As illustrated in FIG. 6, a received signal 610 is filtered by filter 620, REs 630 for an assigned reception BW are selected by BW selector 635, unit 640 applies a Fast Fourier Transform (FFT), and an output is serialized by a parallel-to-serial converter 650. Subsequently, a demodulator 660 coherently demodulates data symbols by applying a channel estimate obtained from a DMRS or a CRS (not shown), and a decoder 670, such as a turbo decoder, decodes the demodulated data to provide an estimate of the information data bits 680. Additional functionalities such as time-windowing, cyclic prefix removal, de-scrambling, channel estimation, and de-interleaving are not shown for brevity.

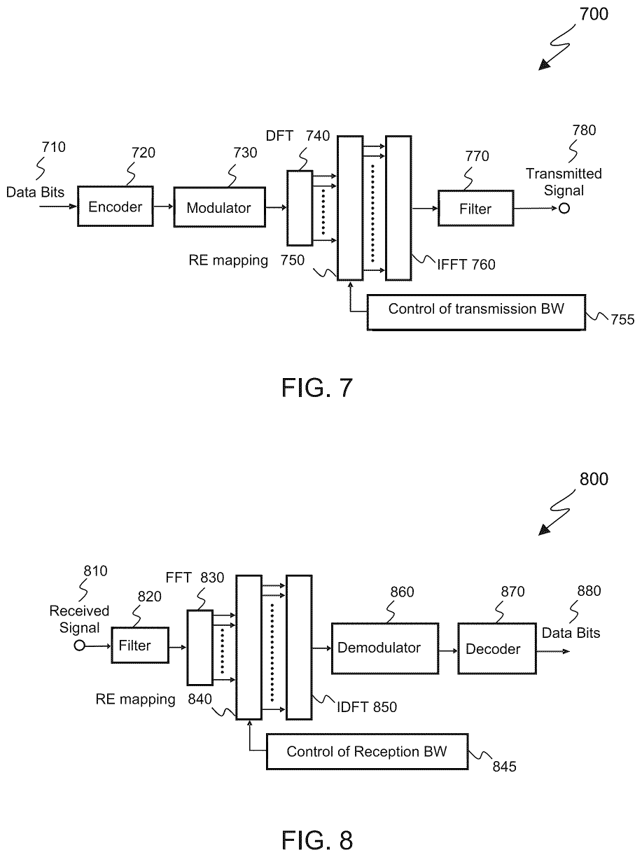

FIG. 7 illustrates an example of a transmitter structure 700 for PUSCH in a subframe according to embodiments of the present disclosure. For example, transmitter structure 700 can be implemented in gNB 102 of FIG. 1. This example is for illustration only and other embodiments can be used without departing from the scope of the present disclosure.

As illustrated in FIG. 7, information data bits 710 are encoded by encoder 720, such as a turbo encoder, and modulated by modulator 730. A Discrete Fourier Transform (DFT) unit 740 applies a DFT on the modulated data bits, REs 750 corresponding to an assigned PUSCH transmission BW are selected by transmission BW selection unit 755, unit 760 applies an IFFT and, after a cyclic prefix insertion (not shown), filtering is applied by filter 770 and a signal transmitted 780.

FIG. 8 illustrates an example of a receiver structure 800 for a PUSCH in a subframe according to embodiments of the present disclosure. For example, receiver structure 800 can be implemented by any of the UEs 111-116 of FIG. 1. This example is for illustration only and other embodiments can be used without departing from the scope of the present disclosure.

As illustrated in FIG. 8, a received signal 810 is filtered by filter 820. Subsequently, after a cyclic prefix is removed (not shown), unit 830 applies a FFT, REs 840 corresponding to an assigned PUSCH reception BW are selected by a reception BW selector 845, unit 850 applies an Inverse DFT (IDFT), a demodulator 860 coherently demodulates data symbols by applying a channel estimate obtained from a DMRS (not shown), a decoder 870, such as a turbo decoder, decodes the demodulated data to provide an estimate of the information data bits 880.

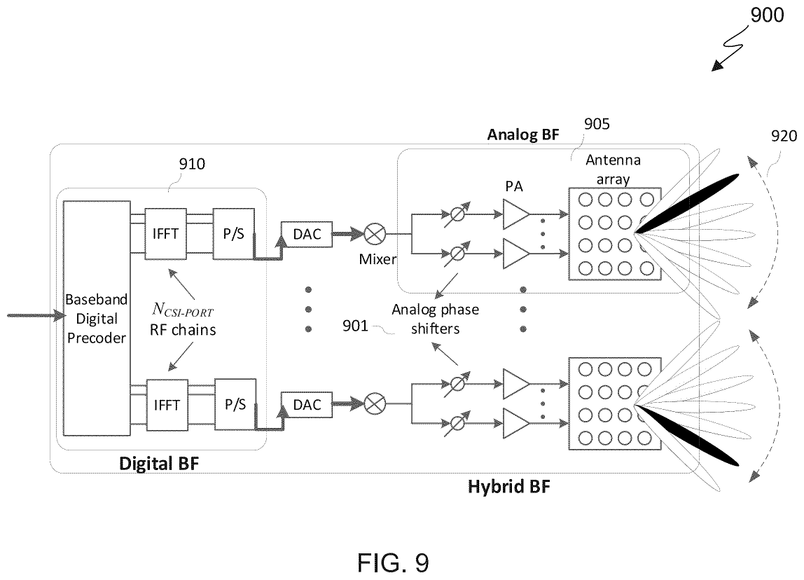

FIG. 9 illustrates an example of a transmitter structure 900 for beamforming according to embodiments of the present disclosure. In certain embodiments, one or more of gNB 102 or UE 116 includes the transmitter structure 900. For example, one or more of antenna 205 and its associated systems or antenna 305 and its associated systems can be included in transmitter structure 900. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 9. Then, one CSI-RS port can be mapped onto a large number of antenna elements that can be controlled by a bank of analog phase shifters 901. One CSI-RS port can then correspond to one sub-array which produces a narrow analog beam through analog beamforming 905. This analog beam can be configured to sweep across a wider range of angles 920 by varying the phase shifter bank across symbols or slots/subframes. The number of sub-arrays (equal to the number of RF chains) is the same as the number of CSI-RS ports N_{CS-PORT}. A digital beamforming unit 910 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 900 of FIG. 9 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 9 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

In the present disclosure, the frequency resolution (reporting granularity) and span (reporting bandwidth) of CSI or calibration coefficient reporting can be defined in terms of frequency “subbands” and “CSI reporting band” (CRB), respectively.

A subband for CSI or calibration coefficient reporting is defined as a set of contiguous PRBs which represents the smallest frequency unit for CSI or calibration coefficient reporting. The number of PRBs in a subband can be fixed for a given value of DL system bandwidth, configured either semi-statically via higher layer/RRC signaling, or dynamically via L1 DL control signaling or MAC control element (MAC CE). The number of PRBs in a subband can be included in CSI or calibration coefficient reporting setting. The term “CSI reporting band” is defined as a set/collection of subbands, either contiguous or non-contiguous, wherein CSI or calibration coefficient reporting is performed. For example, CSI or calibration coefficient reporting band can include all the subbands within the DL system bandwidth. This can also be termed “full-band”. Alternatively, CSI or calibration coefficient reporting band can include only a collection of subbands within the DL system bandwidth. This can also be termed “partial band”. The term “CSI reporting band” is used only as an example for representing a function. Other terms such as “CSI reporting subband set” or “CSI or calibration coefficient reporting bandwidth” can also be used.

In terms of UE configuration, a UE can be configured with at least one CSI or calibration coefficient reporting band. This configuration can be semi-static (via higher layer signaling or RRC) or dynamic (via MAC CE or L1 DL control signaling). When configured with multiple (N) CSI or calibration coefficient reporting bands (e.g., via RRC signaling), a UE can report CSI associated with n≤N CSI reporting bands. For instance, >6 GHz, large system bandwidth may require multiple CSI or calibration coefficient reporting bands. The value of n can either be configured semi-statically (via higher layer signaling or RRC) or dynamically (via MAC CE or L1 DL control signaling). Alternatively, the UE can report a recommended value of n via an UL channel.

Therefore, CSI parameter frequency granularity can be defined per CSI reporting band as follows. A CSI parameter is configured with “single” reporting for the CSI reporting band with Mn subbands when one CSI parameter for all the Mₙ subbands within the CSI reporting band. A CSI parameter is configured with “subband” for the CSI reporting band with Mn subbands when one CSI parameter is reported for each of the Mn subbands within the CSI reporting band.

In certain embodiments, 5G NR radio supports time-division duplex (TDD) operation and frequency division duplex (FDD) operation. Use of FDD or TDD depends on the NR frequency band and per-country allocations. TDD is required in most bands above 2.5 GHz.

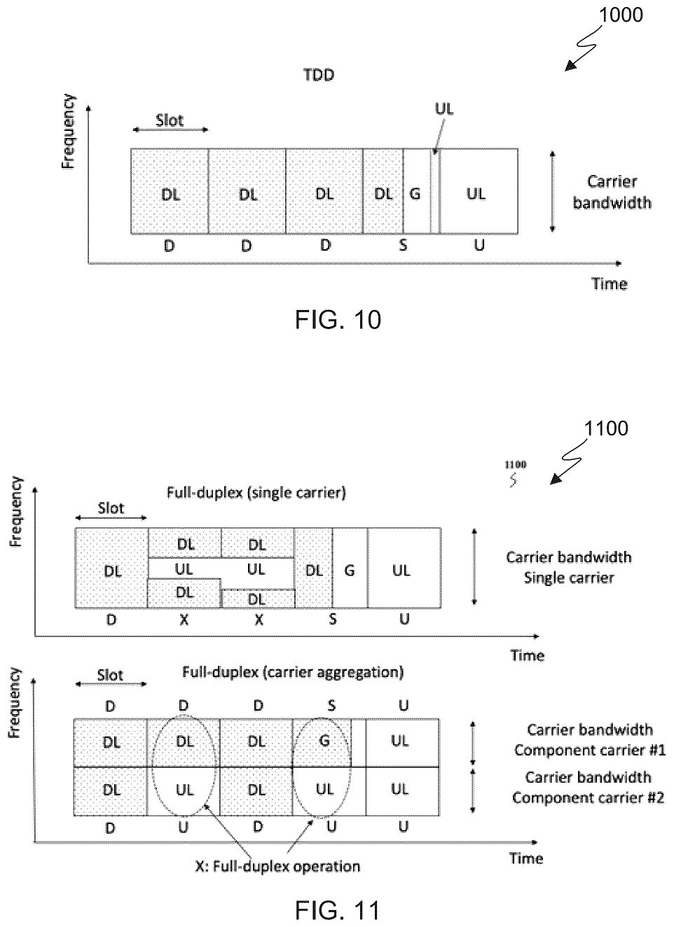

FIG. 10 illustrates a timeline 1000 of an example TDD configuration according to embodiments of the present disclosure. For example, the timeline 1000 of an example TDD configuration can be followed by any of the UEs 111-116 and the gNB 102 of FIG. 1. This example is for illustration only and other embodiments can be used without departing from the scope of the present disclosure.

With reference to FIG. 10, a DDDSU UL-DL configuration is shown in FIG. 10. Here, D denotes a DL slot, U denotes an UL slot, and S denotes a special or switching slot with a DL part, a flexible part that can also be used as guard period G for DL-to-UL switching, and optionally an UL part.

TDD has a number of advantages over FDD. For example, use of the same band for DL and UL transmissions leads to simpler UE implementation with TDD because a duplexer is not required. Another advantage is that time resources can be flexibly assigned to UL and DL considering an asymmetric ratio of traffic in both directions. DL is typically assigned most time resources in TDD to handle DL-heavy mobile traffic. Another advantage is that CSI can be more easily acquired via channel reciprocity. This reduces an overhead associated with CSI reports especially when there is a large number of antennas.

Although there are advantages of TDD over FDD, there are also disadvantages. A first disadvantage is a smaller coverage of TDD due to the smaller portion of time resources available for transmissions from a UE, while with FDD all time resources can be used. Another disadvantage is latency. In TDD, a timing gap between reception by a UE and transmission from a UE containing the hybrid automatic repeat request acknowledgement (HARQ-ACK) information associated with receptions by the UE is typically larger than that in FDD, for example by several milliseconds. Therefore, the HARQ round trip time in TDD is typically longer than that with FDD, especially when the DL traffic load is high. This causes increased UL user plane latency in TDD and can cause data throughput loss or even HARQ stalling when a PUCCH providing HARQ-ACK information needs to be transmitted with repetitions in order to improve coverage (an alternative in such case is for a network to forgo HARQ-ACK information at least for some transport blocks in the DL).

To address some of the disadvantages for TDD operation, an adaptation of link direction based on physical layer signaling using a DCI format is supported where, with the exception of some symbols in some slots supporting predetermined transmissions such as for SSBs, symbols of a slot can have a flexible direction (UL or DL) that a UE can determine according to scheduling information for transmissions or receptions. A PDCCH can also be used to provide a DCI format, such as a DCI format 2_0 as described in [3], that can indicate a link direction of some flexible symbols in one or more slots. Nevertheless, in actual deployments, it is difficult for a gNB scheduler to adapt a transmission direction of symbols without coordination with other gNB schedulers in the network. This is because of CLI where, for example, DL receptions in a cell by a UE can experience large interference from UL transmissions in the same or neighboring cells from other UEs.

Full-duplex (FD) communications offer a potential for increased spectral efficiency, improved capacity, and reduced latency in wireless networks. When using FD communications, UL and DL signals are simultaneously received and transmitted on fully or partially overlapping, or adjacent, frequency resources, thereby improving spectral efficiency and reducing latency in user and/or control planes.

There are several options for operating a FD wireless communication system. For example, a single carrier may be used such that transmissions and receptions are scheduled on same time-domain resources, such as symbols or slots. Transmissions and receptions on same symbols or slots may be separated in frequency, for example by being placed in non-overlapping sub-bands. An UL frequency sub-band, in time-domain resources that also include DL frequency sub-bands, may be located in the center of a carrier, or at the edge of the carrier, or at a selected frequency-domain position of the carrier. The allocations of DL sub-bands and UL sub-bands may also partially or even fully overlap. A gNB may simultaneously transmit and receive in time-domain resources using same physical antennas, antenna ports, antenna panels and transmitter-receiver units (TRX). Transmission and reception in FD may also occur using separate physical antennas, ports, panels, or TRXs. Antennas, ports, panels, or TRXs may also be partially reused, or only respective subsets can be active for transmissions and receptions when FD communication is enabled.

When a UE receives signals/channels from a gNB in a full-duplex slot, the receptions may be scheduled in a DL subband of the full-duplex slot. When full-duplex operation at the gNB uses DL slots for scheduling transmissions from the UE using full-duplex transmission and reception at the gNB, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB uses UL slots for purpose of scheduling transmissions to UEs using full-duplex transmission and reception at the gNB, there may be one or multiple, such as two, UL subbands in the full-duplex slot. Full-duplex operation using an UL subband or a DL subband may be referred to as Subband-Full-Duplex (SBFD).

For example, when full-duplex operation at the gNB uses a DL or F slot or symbol for scheduling transmissions from the UE using full-duplex transmission and reception at the gNB, there may be one DL subband on the full-duplex slot or symbol and one UL subband of the full-duplex slot or symbol in the NR carrier. A frequency-domain configuration of the DL and UL subbands may then be referred to as ‘DU’ or ‘UD’, respectively, depending on whether the UL subband is configured/indicated in the upper or the lower part of the NR carrier. In another example, when full-duplex operation at the gNB uses a DL or F slot or symbol for scheduling transmissions from the UE using full-duplex transmission and reception at the gNB, there may be two, DL subbands and one UL subband on the full-duplex slot or symbol. A frequency-domain configuration of the DL and UL subbands may then be referred to as ‘DUD’ when the UL subband is configured/indicated in a part of the NR carrier and the DL subbands are configured/indicated at the edges of the NR carrier, respectively.

In the following, for brevity, full-duplex slots/symbols and SBFD slots/symbols may be jointly referred to as SBFD slots/symbol and non-full-duplex slots/symbols and normal DL or UL slot/symbols may be referred to as non-SBFD slots/symbols.

Instead of using a single carrier, it is also possible to use different component carriers (CCs) for receptions and transmissions by a UE. For example, receptions by a UE can occur on a first CC and transmissions by the UE occur on a second CC having a small, including zero, frequency separation from the first CC. For example, when carrier-aggregation based full-duplex operation is used, an SBFD subband may correspond to a component carrier or a part of a component carrier or an SBFD subband may be allocated using parts of multiple component carriers.

In one example, the gNB may support full-duplex operation, e.g., support simultaneous DL transmission to a UE in an SBFD DL subband and UL reception from a UE in an SBFD UL subband on an SBFD slot or symbol. In one example, the gNB-side may support full-duplex operation using multiple TRPs, e.g., TRP A may be used for simultaneous DL transmission to a UE and TRP B for UL reception from a UE on an SBFD slot or symbol.

Full-duplex operation may be supported by a half-duplex UE or by a full-duplex UE. A UE operating in half-duplex mode can transmit or receive but cannot simultaneously transmit and receive on a same symbol. A UE operating in full-duplex mode can simultaneously transmit and receive on a same symbol. For example, a UE can operate in full-duplex mode on a single NR carrier or based on the use of intra-band or inter-band carrier aggregation.

For example, when the UE is capable of full-duplex operation, SBFD operation based on overlapping or non-overlapping subbands or using one or multiple UE antenna panels may be supported by the UE. In one example, an FR2-1 UE may support simultaneous transmission to the gNB and reception from the gNB on a same time-domain resource, e.g., symbol or slot. The UE capable of full-duplex operation may then be configured, scheduled, assigned or indicated with DL receptions from the gNB in an SBFD DL subband on a same SBFD symbol where the UE is configured, scheduled, assigned or indicated for UL transmissions to the gNB on an SBFD UL subband. In one example, the DL receptions by a UE may use a first UE antenna panel while the UL transmissions from the UE may use a second UE antenna panel on the same SBFD symbol/slot. For example, UE-side self-interference cancellation capability may be supported in the UE by one or a combination of techniques as described in the gNB case, e.g., based on spatial isolation provided by the UE antennas or UE antenna panels, or based on analog and/or digital equalization, or filtering. In one example, DL receptions by the UE in a first frequency channel, band or frequency range, may use a TRX of a UE antenna or UE antenna panel while the UL transmissions from the UE in a second frequency channel, band or frequency range may use the TRX on a same SBFD symbol/slot. For example, when the UE is capable of full-duplex operation based on the use of carrier aggregation, simultaneous DL reception from the gNB and UL transmission to the gNB on a same symbol may occur on different component carriers. In the following, for brevity, a UE operating in half-duplex mode but supporting a number of enhancements for gNB-side full-duplex operation may be referred to as SBFD-aware UE. For example, the SBFD-aware UE may support time-domain or frequency-domain resource allocation enhancements to improve the UL coverage or throughput or spectral efficiency when operating on a serving cell with gNB-side SBFD support.

In the following, for brevity, a UE operating in full-duplex mode may be referred to as SBFD-capable UE, or as full-duplex capable UE, or as a full-duplex UE. A full-duplex UE may support a number of enhancements for gNB-side full-duplex operation. For example, the SBFD-capable UE may support time-domain or frequency-domain resource allocation enhancements to improve the UL coverage or throughput or spectral efficiency when operating on a serving cell.

In one example, a gNB may operate in full-duplex (or SBFD) mode and a UE operates in half-duplex mode. In one example, a gNB may operate in full-duplex (or SBFD) mode and a UE operates in full-duplex (or SBFD) mode. In one example, gNB-side support of full-duplex (or SBFD) operation is based on multiple TRPs wherein a TRP may operate in half-duplex mode, and a UE operates in full-duplex mode.

In one example, a TDD serving cell supports a mix of full-duplex and half-duplex UEs. For example, UE1 supports full-duplex operation and UE2 supports half-duplex operation. The UE1 can transmit and receive simultaneously in a slot or symbol when configured, scheduled, assigned or indicated by the gNB. UE2 can either transmit or receive in a slot or symbol while simultaneous DL reception by UE2 and UL transmission from UE2 cannot occur on the same slot or symbol.

FD transmission/reception is not limited to gNBs, TRPs, or UEs, but can also be used for other types of wireless nodes such as relay or repeater nodes.

Embodiments of the present invention recognize full duplex operation needs to overcome several challenges in order to be functional in actual deployments. When using overlapping frequency resources, received signals are subject to co-channel CLI and self-interference. CLI and self-interference cancellation methods include passive methods that rely on isolation between transmit and receive antennas, active methods that utilize RF or digital signal processing, and hybrid methods that use a combination of active and passive methods. Filtering and interference cancellation may be implemented in RF, baseband (BB), or in both RF and BB. While mitigating co-channel CLI may require large complexity at a receiver, it is feasible within current technological limits. Another aspect of FD operation is the mitigation of adjacent channel CLI because in several cellular band allocations, different operators have adjacent spectrum.

Throughout the disclosure, the term Full-Duplex (FD) is used as a short form for a full-duplex operation in a wireless system. The terms ‘cross-division-duplex’ (XDD), ‘full duplex’ (FD) and ‘subband-full-duplex’ (SBFD) may be used interchangeably in the disclosure.

FD operation in NR can improve spectral efficiency, link robustness, capacity, and latency of UL transmissions. In an NR TDD system, transmissions from a UE are limited by fewer available transmission opportunities than receptions by the UE. For example, for NR TDD with SCS=30 kHz, DDDU (2 msec), DDDSU (2.5 msec), or DDDDDDDSUU (5 msec), the UL-DL configurations allow for an DL:UL ratio from 3:1 to 4:1. Any transmission from the UE can only occur in a limited number of UL slots, for example every 2, 2.5, or 5 msec, respectively.

FIG. 11 illustrates timelines 1100 of example FD configurations according to embodiments of the present disclosure. For example, timelines 1100 of example FD configurations can be followed by any of the UEs 111-116 and the gNB 102 of FIG. 1. This example is for illustration only and other embodiments can be used without departing from the scope of the present disclosure.

With reference to FIG. 11, for a single carrier TDD configuration with FD enabled, slots denoted as X are FD slots. Both DL and UL transmissions can be scheduled in FD slots for at least one or more symbols. The term FD slot is used to refer to a slot where UEs can simultaneously receive and transmit in at least one or more symbols of the slot if scheduled or assigned radio resources by the base station. A half-duplex UE cannot transmit and receive simultaneously in a FD slot or on a symbol of a FD slot. When a half-duplex UE is configured for transmission in symbols of a FD slot, another UE can be configured for reception in the symbols of the FD slot. A FD UE can transmit and receive simultaneously in symbols of a FD slot, possibly in presence of other UEs with resources for either receptions or transmissions in the symbols of the FD slot. Transmissions by a UE in a first FD slot can use same or different frequency-domain resources than in a second FD slot, wherein the resources can differ in bandwidth, a first RB, or a location of the center carrier.

When a UE receives signals/channels from a gNB in a full-duplex slot, the receptions may be scheduled in a DL subband of the full-duplex slot. When full-duplex operation at the gNB 102 uses DL slots for scheduling transmissions from the UE 116 using full-duplex transmission and reception at the gNB 102, there may be one or multiple, such as two, DL subbands in the full-duplex slot. When a UE is scheduled to transmit in a full-duplex slot, the transmission may be scheduled in an UL subband of the full-duplex slot. When full-duplex operation at the gNB 102 uses UL slots for purpose of scheduling transmissions to UEs using full-duplex transmission and reception at the gNB 102, there may be one or multiple, such as two, UL subbands in the full-duplex slot.

For a carrier aggregation TDD configuration with FD enabled, a UE receives in a slot on CC #1 and transmits in at least one or more symbols of the slot on CC #2. In addition to D slots used only for transmissions/receptions by a gNB/UE, U slots used only for receptions/transmissions by the gNB/UE, and S slots that are used for both transmission and receptions by the gNB/UE and also support DL-UL switching, FD slots with both transmissions/receptions by a gNB or a UE that occur on same time-domain resources, such as slots or symbols, are labeled by X. For the example of TDD with SCS=30 kHz, single carrier, and UL-DL allocation DXXSU (2.5 msec), the second and third slots allow for FD operation. Transmissions from a UE can also occur in a last slot (U) where the full UL transmission bandwidth is available. FD slots or symbol assignments over a time period/number of slots can be indicated by a DCI format in a PDCCH reception and can then vary per unit of the time period, or can be indicated by higher layer signaling, such as via a MAC CE or RRC.

Although FIGS. 10-11 illustrates diagrams, various changes may be made to the diagrams 1000-1100 of FIGS. 10-11. For example, while certain diagrams (such as diagrams 1000, 1100) describe a certain slot structure, various components combined, further subdivided, or omitted and additional components can be added according to particular needs.

In the following and throughout the disclosure, various embodiments of the disclosure may be also implemented in any type of UE including, for example, UEs with the same, similar, or more capabilities compared to legacy 5G NR UEs. Although various embodiments of the disclosure discuss 3GPP 5G NR communication systems, the embodiments may apply in general to UEs operating with other RATs and/or standards, such as next releases/generations of 3GPP, IEEE Wi-Fi, and so on.

The term ‘activation’ describes an operation wherein a UE receives and decodes a signal from the network (or gNB) that signifies a starting point in time. The starting point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal. The term “deactivation” describes an operation wherein a UE receives and decodes a signal from the network (or gNB) that signifies a stopping point in time. The stopping point can be a present or a future slot/subframe or symbol and the exact location is either implicitly or explicitly indicated, or is otherwise specified in the system operation or is configured by higher layers. Upon successfully decoding the signal, the UE responds according to an indication provided by the signal.

In the following, unless otherwise explicitly noted, providing a parameter value by higher layers includes providing the parameter value by a system information block (SIB), such as a SIB1, or by a common RRC signaling, or by UE-specific RRC signaling.

In the following, the suffix ‘-rxx’ is used to denote a parameter that does not currently exist in specifications and can be introduced to support the disclosed functionalities, with ‘xx’ denoting a number of a 3GPP release for the introduction of the parameter, e.g., xx=19 for Rel-19, or xx=20 for Rel-20, etc.

In the following, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from RRC_IDLE or by RRC signaling when the UE is configured with an SCell or additional SCGs by an IE ServingCellConfigCommon in RRC_CONNECTED. The UE determines a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration designates a slot or symbol as one of types ‘D’, ‘U’ or ‘F’ using at least one time-domain pattern with configurable periodicity.

In the following, for brevity of description, SFI refers to a slot format indicator as example that is indicated using higher layer provided IEs such as slotFormatCombination or slotFormatCombinationsPerCell and which is indicated to the UE by group common DCI format such as DCI F2_0 where slotFormats are defined in [3].

Terminology such as TCI, TCI states, SpatialRelationInfo, target RS, reference RS, and other terms is used for illustrative purposes and is therefore not normative. Other terms that refer to same functions can also be used. A “reference RS” corresponds to a set of characteristics of a DL RX beam or an UL TX beam, such as a direction, a precoding/beamforming, a number of ports, and so on. A beam may also be referred to as spatial filter or spatial setting and be associated with a TCI state for quasi co-location (QCL) properties.

Using Rel-15 NR, a UE can monitor multiple candidate locations for respective potential PDCCH receptions to decode multiple DCI formats in a slot, for example as described in [3]. A DCI format includes cyclic redundancy check (CRC) bits in order for the UE to confirm a correct detection of the DCI format. A DCI format type is identified by a radio network temporary identifier (RNTI) that scrambles the CRC bits, for example as described in [2].

For a DCI format scheduling a PDSCH or a PUSCH to a single UE, the RNTI can be a cell RNTI (C-RNTI), or a configured scheduling RNTI (CS-RNTI), or an MCS-C-RNTI and serves as a UE identifier. In the following, for brevity, only the C-RNTI will be referred to when needed. A UE typically receives/monitors PDCCH for detections of DCI formats with CRC scrambles by a C-RNTI according to a UE-specific search space (USS).

For a DCI format scheduling a PDSCH conveying system information (SI), the RNTI can be an SI-RNTI. For a DCI format scheduling a PDSCH providing a random-access response (RAR), the RNTI can be an RA-RNTI. For a DCI format scheduling a PDSCH providing paging information, the RNTI can be a P-RNTI. There are also a number of other RNTIs that are provided to a UE by UE-specific RRC signaling and are associated with DCI formats providing various control information and are monitored according to a common search space (CSS). Such DCI formats include a DCI format 2_0 providing a structure of a slot in term of DL, UL or flexible/reserved symbols over a number of slots, a DCI format 2_2 providing transmit power control (TPC) commands for PUSCH or PUCCH transmissions, a DCI format 2_3 providing TPC commands for SRS transmissions and also potentially triggering a SRS transmission on a number of cells, and so on, and a corresponding CSS is referred to as Type3-PDCCH CSS.

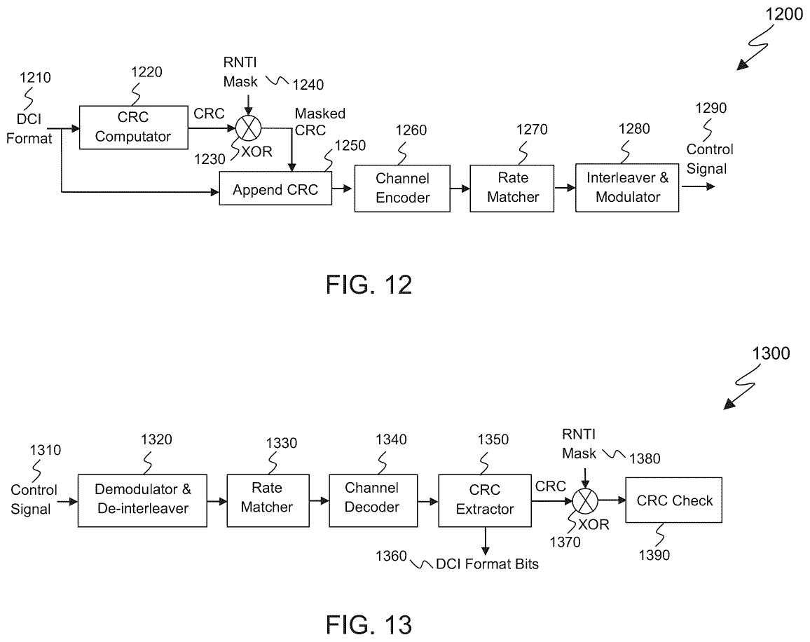

FIG. 12 illustrates an example of a transmitter structure 1200 for a PDCCH according to embodiments of the present disclosure. For example, transmitter structure 1200 may be implemented by a gNB 102 of FIG. 1. This example is for illustration only and other embodiments can be used without departing from the scope of the present disclosure.

As illustrated in FIG. 12, a gNB separately encodes and transmits each DCI format in a respective PDCCH. When applicable, a RNTI for a UE that a DCI format is intended for masks a CRC of the DCI format codeword in order to enable the UE to identify the DCI format. For example, the CRC can include 16 bits or 24 bits and the RNTI can include 16 bits or 24 bits. Otherwise, when a RNTI is not included in a DCI format, a DCI format type indicator field can be included in the DCI format. The CRC of (non-coded) DCI format bits 1210 is determined using a CRC computation unit 1220, and the CRC is masked using an exclusive OR (XOR) operation unit 1230 between CRC bits and RNTI bits 1240. The XOR operation is defined as XOR(0,0)=0, XOR(0,1)=1, XOR(1,0)=1, XOR(1,1)=0. The masked CRC bits are appended to DCI format information bits using a CRC append unit 1250. An encoder 1260 performs channel coding (such as tail-biting convolutional coding or polar coding), followed by rate matching to allocated resources by rate matcher 1270. Interleaving and modulation units 1280 apply interleaving and modulation, such as QPSK, and the output control signal 1290 is transmitted.

FIG. 13 illustrates an example of a receiver structure 1300 for a PDCCH according to embodiments of the present disclosure. For example, receiver structure 1300 may be implemented by any of the UEs 111-116 of FIG. 1. This example is for illustration only and other embodiments can be used without departing from the scope of the present disclosure.

As illustrated in FIG. 13, a received control signal 1310 is demodulated and de-interleaved by a demodulator and a de-interleaver 1320. A rate matching applied at a gNB transmitter is restored by rate matcher 1330, and resulting bits are decoded by decoder 1340. After decoding, a CRC extractor 1350 extracts CRC bits and provides DCI format information bits 1360. The DCI format information bits are de-masked 1370 by an XOR operation with a RNTI 1380 (when applicable) and a CRC check is performed by unit 1390. When the CRC check succeeds (checksum is zero), the DCI format information bits are considered to be valid. When the CRC check does not succeed, the DCI format information bits are considered to be invalid.

A PDCCH transmission can be within a set of PRBs. A gNB can configure a UE one or more sets of PRB sets, also referred to as control resource sets (CORESETs), for PDCCH receptions as described in [3]. A PDCCH reception can be in control channel elements (CCEs) that are included in a CORESET. A UE can monitor PDCCH according to a first PDCCH monitoring type or according to a second PDCCH monitoring type. For the first PDCCH monitoring type, a maximum number of PDCCH candidates M_{PDCCH}^{max,slot,μ}, and a maximum number of non-overlapping CCEs C_{PDCCH}^{max,slot,μ}, for the reception of PDCCH candidates is defined per slot. Non-overlapping CCEs are CCEs with different indexes or in different symbols of a CORESET or in different CORESETs.

If a UE can support a first set of N_{cells,0}^{DL} serving cells where the UE is either not provided CORESETPoolIndex or is provided CORESETPoolIndex with a single value for all CORESETs on all DL BWPs of each serving cell from the first set of serving cells, and a second set of N_{cells,1}^{DL} serving cells where the UE is provided CORESETPoolIndex with a value 0 for a first CORESET and with a value 1 for a second CORESET on any DL BWP of each serving cell from the second set of serving cells, the UE determines, for the purpose of reporting pdcch-BindDetectionCA, a number of serving cells as N_{cells,0}^{DL}+R·N_{cells,1}^{DL} where R is a value reported by the UE.

If a UE is configured with N_{cells,0}^{DL,μ}+N_{cells,1}^{DL,μ} downlink cells, with associated PDCCH candidates monitored in the active DL BWPs of the scheduling cell(s) using SCS configuration μ, where Σ_{μ=0}³(N_{cells,0}^{DL,μ}+γ·N_{cells,1}^{DL,μ})>N_{cells}^{cap}, and a DL BWP of an activated cell is the active DL BWP of the activated cell, and a DL BWP of a deactivated cell is the DL BWP with index provided by firstActiveDownlinkBWP-Id for the deactivated cell, the UE is not required to monitor more than M_{PDCCH}^{total,slot,μ}=└N_{cells}^{cap}·M_{PDCCH}^{max,slot,μ}·(N_{cells,0}^{DL,μ}+γ·N_{cells,1}^{DL,μ})/Σⱼ₌₀³(N_{cells,0}^{DL,j}+γ·N_{cells,1}^{DL,j})┘ PDCCH candidates or more than C_{PDCCH}^{total,slot,μ}=└N_{cells}^{cap}·C_{PDCCH}^{max,slot,μ}·(N_{cells,0}^{DL,μ}+γ·N_{cells,1}^{DL,μ})/Σⱼ₌₀³(N_{cells,0}^{DL,j}+γ·N_{cells,1}^{DL,j})┘ non-overlapped CCEs per slot on the active DL BWP(s) of scheduling cell(s) from the N_{cells,0}^{DL,μ}+N_{cells,1}^{DL,μ} downlink cells, where N_{cells}^{cap} is either equal to 4 or is a capability reported by the UE, and γ is a value that is either provided by higher layers to the UE or, otherwise, γ=R.

For each scheduled cell, the UE is not required to monitor on the active DL BWP with SCS configuration μ of the scheduling cell from the N_{cells,0}^{DL,μ} downlink cells more than min(M_{PDCCH}^{max,slot,μ},M_{PDCCH}^{total,slot,μ}) PDCCH candidates or more than min(C_{PDCCH}^{max,slot,μ},C_{PDCCH}^{total,slot,μ}) non-overlapped CCEs per slot.

For each scheduled cell, the UE is not required to monitor on the active DL BWP with SCS configuration μ of the scheduling cell from the N_{cells,1}^{DL,μ} downlink cells more than min(γ·M_{PDCCH}^{max,slot,μ},M_{PDCCH}^{total,slot,μ}) PDCCH candidates or more than min(γ·C_{PDCCH}^{max,slot,μ},C_{PDCCH}^{total,slot,μ}) non-overlapped CCEs per slot, more than min(M_{PDCCH}^{max,slot,μ},M_{PDCCH}^{total,slot,μ}) PDCCH candidates or more than min(C_{PDCCH}^{max,slot,μ},C_{PDCCH}^{total,slot,μ}) non-overlapped CCEs per slot for CORESETs with same CORESETPoolIndex value.

If a CORESETPoolIndex is not provided for a cell or if a single CORESETPoolIndex is provided for a cell, then γ=0.

A UE determines CCEs for decoding a PDCCH candidate based on a search space as described in [3]. For some RNTIs, such as a C-RNTI, a set of PDCCH candidates for respective DCI formats defines corresponding UE-specific search space sets (USS sets) as described in [3] and [6]. For other RNTIs, such as a SI-RNTI, a set of PDCCH candidates for respective DCI formats defines corresponding common search space sets (CSS sets). A search space set is associated with a CORESET where the UE monitors PDCCH candidates for the search space set. A UE expects to monitor PDCCH candidates for up to 4 sizes of DCI formats that include up to 3 sizes of DCI formats with CRC scrambled by C-RNTI or MCS-C-RNTI per serving cell. The UE counts a number of sizes for DCI formats per serving cell based on a number of configured PDCCH candidates in respective search space sets for the corresponding active DL BWP.

For cross-carrier scheduling, the number of PDCCH candidates for monitoring and the number of non-overlapped CCEs per span or per slot are separately counted for each scheduled cell.

For a search space set s associated with CORESET p, the CCE indexes for aggregation level L corresponding to PDCCH candidate m_{s,n}_{_{CI}} of the search space set in slot n_{s,f}^{μ} for an active DL BWP of a serving cell corresponding to carrier indicator field value n_{CI} are given by L·

$$\{ ( {Y}_{p , {n}_{s , f}^{μ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ {N}_{CCE , p} / L ⌋ \} + i$$

where for any CSS, Y_{p,n}_{_{s,f}}_{^{μ}}=0; for a USS, Y_{p,n}_{_{s,f}}_{^{μ}}=(Aₚ·Y_{p,n}_{_{s,f}}_{^{μ}}₋₁)modD, Y_{p,-1}=n_{RNTI}≠0, Aₚ=39827 for pmod3=0, Aₚ=39829 for pmod3=1, Aₚ=39839 for pmod3=2, and D=65537; i=0, . . . , L−1; N_{CCE,p} is a number of CCEs, numbered from 0 to N_{CCE,p}−1, in CORESET p; n_{CI} is a carrier indicator field value if the UE is configured with a carrier indicator field for the serving cell on which PDCCH is monitored; otherwise, including for any CSS, n_{CI}=0; m_{s,n}_{_{CI}}=0, . . . , M_{s,n}_{_{CI}}^{(L)}−1, where M_{s,n}_{_{CI}}^{(L)} is the number of PDCCH candidates the UE is configured to monitor for aggregation level L of a search space set s for a serving cell corresponding to n_{CI}; for any CSS, M_{s,max}^{(L)}=M_{s,0}^{(L)} for a USS, M_{s,max}^{(L)} is the maximum of M_{s,n}_{_{CI}}^{(L)} over all configured n_{CI} values for a CCE aggregation level L of search space set s; the RNTI value used for n_{RNTI} is the C-RNTI.

A UE monitors PDCCH according to a CSS for scheduling a PDSCH providing system information, random access response, or paging only on one cell that is referred to as primary cell. The UE transmits PUCCH only on the primary cell. The UE can also be configured a primary secondary cell (PSCell) for PUCCH transmissions and then the UE transmits PUCCH on the primary cell for a master/primary cell group and transmits PUCCH on the PSCell for a secondary cell group. For brevity and descriptive conciseness, this disclosure considers examples for a primary cell, but the embodiments may be applied to a PSCell.

For all search space sets within a slot n or within a span in slot n, denote by S_{css} a set of CSS sets with cardinality of I_{css} and by Sᵤₛₛ a set of USS sets with cardinality of J_{css}. The location of USS sets sⱼ, 0≤j<Jᵤₛₛ, in Sᵤₛₛ is according to an ascending order of the search space set index.

Denote by Mₛ_{_{css}}₍ᵢ₎^{(L)}, 0≤i<I_{css}, the number of counted PDCCH candidates for monitoring for CSS set S_{css}(i) and by Mₛ_{ᵤₛₛ}₍ⱼ₎^{(L)}, 0≤j<Jᵤₛₛ, the number of counted PDCCH candidates for monitoring for USS set Sᵤₛₛ(j). For the CSS sets, a UE monitors M_{PDCCH}^{CSS}=Σᵢ₌₀^{I}^{_{css}}⁻¹Σ_{L}Mₛ_{_{css}}₍ᵢ₎^{(L)} PDCCH candidates requiring a total of C_{PDCCH}^{CSS} non-overlapping CCEs in a slot or in a span.

The UE allocates PDCCH candidates for monitoring to USS sets for the primary cell having an active DL BWP with SCS configuration μ in a slot according to the following pseudocode. If for the USS sets for scheduling on the primary cell the UE is not provided CORESETPoolIndex for first CORESETs or is provided CORESETPoolIndex with value 0 for first CORESETs, and is provided CORESETPoolIndex with value 1 for second CORESETs, and if min(γ·M_{PDCCH}^{max,slot,μ},M_{PDCCH}^{total,slot,μ})>min(M_{PDCCH}^{max,slot,μ},M_{PDCCH}^{total,slot,μ}) or min(γ·C_{PDCCH}^{max,slot,μ},C_{PDCCH}^{total,slot,μ})>min(C_{PDCCH}^{max,slot,μ},C_{PDCCH}^{total,slot,μ}), the following pseudocode applies only to USS sets associated with the first CORESETs. A UE does not expect to monitor PDCCH in a USS set without allocated PDCCH candidates for monitoring.

Denote by V_{CCE}(Sᵤₛₛ(j)) the set of non-overlapping CCEs for search space set Sᵤₛₛ(j) and by C(V_{CCE}(Sᵤₛₛ(j))) the cardinality of V_{CCE}(Sᵤₛₛ(j)) where the non-overlapping CCEs for search space set Sᵤₛₛ(j) are determined considering the allocated PDCCH candidates for monitoring for the CSS sets and the allocated PDCCH candidates for monitoring for all search space sets Sᵤₛₛ(k), 0≤k≤j. Set M_{PDCCH}^{uss}=min(M_{PDCCH}^{max,slot,μ},M_{PDCCH}^{total,slot,μ})=M_{DPCCH}^{css}. Set C_{PDCCH}^{uss}=min(C_{PDCCH}^{max,slot,μ},C_{PDCCH}^{total,slot,μ})=C_{PDCCH}^{css}. Set j=0. While Σ_{L} Mₛ_{ᵤₛₛ}₍ⱼ₎^{(L)}≤M_{PDCCH}^{uss} AND C(V_{CCE}(Sᵤₛₛ(j)))≤C_{PDCCH}^{uss} allocate Σ_{L} Mₛ_{ᵤₛₛ}₍ⱼ₎^{(L)}≤M_{PDCCH}^{uss} candidates for monitoring to USS set Sᵤₛₛ(j). Determine M_{PDCCH}^{uss}=M_{PDCCH}^{uss}−Σ_{L}Mₛ_{ᵤₛₛ}₍ⱼ₎^{(L)}; C_{PDCCH}^{uss}=C_{PDCCH}^{uss}−C(V_{CCE}(Sᵤₛₛ(j))); j=j+1; then the while loop ends.

An ability of a gNB to schedule a UE on a cell depends on a maximum PDCCH monitoring capability of the UE for scheduling on the cell as defined by min(M_{PDCCH}^{max,slot,μ},M_{PDCCH}^{total,slot,μ}) PDCCH candidates and min(C_{PDCCH}^{max,slot,μ},C_{PDCCH}^{total,slot,μ}) non-overlapped CCEs per slot for a scheduling cell from the N_{cells,0}^{DL,μ} downlink cells or by min(γ·M_{PDCCH}^{max,slot,μ},M_{PDCCH}^{total,slot,μ}) PDCCH candidates and min(γ·C_{PDCCH}^{max,slot,μ},C_{PDCCH}^{total,slot,μ}) for a scheduling cell from the N_{cells,1}^{DL,μ} downlink cells. While M_{PDCCH}^{max,slot,μ} and C_{PDCCH}^{max,slot,μ} are predetermined numbers for a SCS configuration μ, M_{PDCCH}^{total,slot,μ} and C_{PDCCH}^{total,slot,μ} are variable and depend on a total number of cells for SCS configuration μ, N_{cells,0}^{DL,μ}+γ·N_{cells,1}^{DL,μ}, and on a total number of cells across all SCS configurations Σⱼ₌₀³(N_{cells,0}^{DL,μ}+γ·N_{cells,1}^{DL,μ}). Determining M_{PDCCH}^{total,slot,μ} and C_{PDCCH}^{total,slot,μ} based on a number of configured cells results to an under-dimensioning of the PDCCH monitoring capability of the UE as, at a given time, the UE can deterministically know that it cannot be scheduled in certain cells and therefore a corresponding PDCCH monitoring capability can be reallocated to other cells where scheduling can occur.

For a UE in RRC_CONNECTED mode, PDCCH monitoring activity of the UE may be controlled in several ways by a serving gNB using higher layer signaling through bandwidth part (BWP) adaptation, or discontinuous reception (DRX) as described in [3], [5], and [6]. The PDCCH monitoring activity of the UE can be further controlled by the Rel-16 NR feature for UE power savings using DCI format 2_6 with CRC scrambled by PS-RNTI (DCP), and by Rel-17 NR PDCCH adaptation features such as PDCCH skipping and search space set group (SSSG) switching as described in [3].

Using Rel-15 NR and when a gNB configures BWP adaptation to a UE, the gNB may set transmission and reception bandwidths for the UE to be smaller than the NR carrier bandwidth. Up to 4 DL or UL BWPs may be configured for a UE. For operation in unpaired spectrum, i.e., TDD, a DL BWP and UL BWP in a DL/UL BWP pair have a same center frequency. A UE has only one active DL BWP for receptions and only one active UL BWP for transmissions at any given time. A UE monitors PDCCH on the one active DL BWP i.e., the UE does not have to monitor PDCCH on the entire DL frequency of the cell or on configured DL BWPs that are not active. A BWP inactivity timer (independent from the DRX inactivity timer) may be used for a UE to switch an active DL BWP to a default DL BWP when multiple DL BWPs are available for the UE. The UE restarts the BWP inactivity timer upon successful decoding of a DCI format and the change to the default DL BWP occurs when the timer expires as described in [3].

Using Rel-15 NR and when a UE operates with DRX, the UE is not required to continuously monitor the PDCCH on the active BWP. DRX operation in RRC_CONNECTED mode (C-DRX) is based on the use of a configurable DRX cycle for the UE. When a DRX cycle is configured, the UE monitors PDCCH only during the active time. The UE does not need to monitor PDCCH and can switch off receiver circuitry during certain periods of the inactivity time. That operation reduces UE power consumption. The longer the DRX inactive time, the lower the UE power consumption but the larger the latency for scheduling the UE as the gNB scheduler can only reach the UE when the UE is active according to its DRX cycle. Typically, if the UE has been scheduled and is receiving or transmitting data, the UE is likely to be frequently scheduled and waiting until the next activity period according to the DRX cycle would result in additional delays. Therefore, to reduce or avoid such delays, the UE remains in the active state for a configurable time period after being scheduled. That is realized by a DRX inactivity timer that the UE starts every time the UE is scheduled, and the UE remains awake until the timer expires.

Rel-16 NR provides additional features to reduce UE power consumption for UE in RRC_CONNECTED mode such as DCI with CRC scrambled by PS-RNTI (DCP), cross-slot scheduling, or MIMO layer adaptation features. The UE may provide assistance information to the gNB to indicate its preferred radio or protocol configurations, such as its preferred C-DRX configuration, aggregated bandwidth, SCell configuration, MIMO configuration, configuration parameters for an RRC state, or minimum scheduling offset values, for a gNB or network to select a UE radio or UE protocol configuration.

Using Rel-16 NR, when a UE is configured to monitor PDCCH associated with a DCI format 2_6 with CRC scrambled by PS-RNTI (DCP), the UE may be indicated by the DCP whether or not the UE is required to monitor PDCCH on the PCell during a next occurrence of the on-duration of the UE's C-DRX cycle. If the UE does not detect a DCP on the active BWP prior to a next on-duration, the UE does not monitor PDCCH during the next on-duration unless the UE is explicitly indicated by the gNB via prior higher signaling to monitor PDCCH in that case. The DCP feature using DCI format 2_6 may also provide SCell dormancy indication in case the UE has activated SCells. A UE can only be configured to monitor DCP when DRX in RRC_CONNECTED mode (C-DRX) is configured, and at one or more monitoring occasions located at configured offsets before the DRX on-duration. The UE does not monitor DCP on occasions occurring during active time, measurement gaps, BWP switching, or when the UE monitors response for a CFRA preamble transmission for beam failure recovery. If a UE is not configured to monitor PDCCH for DCP, the UE follows normal DRX operation. When the UE operates with CA, the UE may monitor PDCCH for DCP only on the PCell. One DCP can control PDCCH monitoring during a DRX on-duration for one or more UEs independently.

Rel-17 NR provides several additional features in support of reduced UE power consumption for UEs in RRC_IDLE/RRC_INACTIVE or in RRC_CONNECTED modes such as paging enhancements for UEs in RRC_IDLE/RRC_INACTIVE modes, the provision of potential TRS/CSI-RS occasions available in RRC_CONNECTED mode to UEs in RRC_IDLE/RRC_INACTIVE modes, or PDCCH monitoring reduction features including SSSG switching or PDCCH skipping for UEs in RRC_CONNECTED mode, or relaxation of UE measurements for RLM and/or BFD for UEs in RRC_CONNECTED mode.

Using Rel-17 NR, when a UE is configured with a PDCCH monitoring reduction feature, PDCCH monitoring by the UE can be adapted by the gNB for Type3-PDCCH CSS sets or USS sets on the active DL BWP of the serving cell. For example, as described in [3], an adaptation can be triggered using a PDCCH monitoring adaptation indication field in DCI formats 0_1/0_2/1_1/1_2.

For example, SSSG switching may be configured using a Rel-17 configuration of SSSGs provided by higher layers. The UE can be indicated to switch from a first SSSG to a second SSSG for PDCCH monitoring via an indication by a scheduling DCI. If a SSSG switch timer is also configured, the UE switches to the SSSG with lowest group index (e.g., group index 0) after timer expiration if the UE does not detect any DCI format with CRC scrambled by C-RNTI/CS-RNTI/MCS-C-RNTI during the configured timer duration. The associated switching delay is at least P_{switch} symbols, where P_{switch} depends on the numerology of the active DL BWP for the UE on the serving cell as described in [3]. The UE can be configured with up to 3 SSSGs.

For example, PDCCH skipping mechanism may be configured for a UE. A configuration for a set of PDCCH skipping durations is provided to a UE by higher layers. A UE can be indicated to skip PDCCH monitoring for a duration from the set of durations, starting from a next slot after the slot of the PDCCH reception that provides the DCI format with the indication. A UE resumes PDCCH monitoring after the duration. The UE ignores an indication for PDCCH skipping and continues to monitor PDCCH in several cases, for example as described in [3]. For example, one such case is when the UE transmitted a PUCCH with positive SR and has not received a DCI format scheduling a PUSCH transmission. Another such case is when a contention resolution timer is running or during monitoring of the RAR/MsgB window on an SpCell. Several additional cases can exist and are not captured for brevity.

A UE can be configured for both SSSG switching and PDCCH skipping. In such case, the UE performs either SSSG switching or PDCCH skipping based on the indication by the PDCCH monitoring adaptation indication field in a DCI format 0_1/0_2/1_1/1_2 that can indicate either PDCCH skipping or SSSG switching as described in [3].

Rel-15 NR focuses on single Transmit/Receive Point (TRP)-based transmission/reception with ideal backhaul from UE perspective.

Using Rel-16 NR, a serving cell can schedule the UE from two TRPs, providing better coverage, reliability and/or data rates for PDSCH, PDCCH, PUSCH, and PUCCH in multiple Transmit/Receive Point (multi-TRP or mTRP) operation. There are two different operation modes to schedule multi-TRP PDSCH transmissions: single-DCI (or sDCI) and multi-DCI (or mDCI). For both modes, control of UL and DL operation can be done by the physical layer and MAC, within the configuration provided by RRC. In single-DCI mode, the UE is scheduled by a same DCI for receptions from or transmissions to both TRPs. In multi-DCI mode, the UE is scheduled by a separate DCI from each TRP. For example, to improve DL date rate, both single-DCI and multi-DCI based non-coherent joint transmission (NCJT) can be supported.

With reference to detailed procedures according to Rel-16 NR, for multi-DCI-based NCJT transmission, up to 4 transmission layers per PDSCH, a UE may expect to receive two PDCCHs scheduling two fully/partially/non-overlapped PDSCHs respectively in time and frequency domain with same/different PDSCH scrambling ID(s). When the UE is scheduled with fully or partially overlapping PDSCHs, the UE is not expected to assume DM-RS ports in a CDM group indicated by two TCI states. Some configurations related to two received PDSCHs, e.g., active BWP, etc. are expected to be same from UE perspective. The UE can be expected to rate match around configured CRS patterns which are associated with the value of CORESETPoolIndex, i.e., per TRP basis, and applied to the corresponding PDSCH.

For PDCCH monitoring, two TRPs are implicitly associated with two CORESET groups, i.e., up to 3 CORESETs per TRP, respectively each of which can be identified by the value of CORESETPoolIndex. The maximum number of BDs/non-overlapping CCEs for a scheduling cell can be doubled for two TRPs but the maximum number of BDs/non-overlapping CCEs per TRP remains same as in Rel.15 NR.

A scheduling timeline can be relaxed to support out-of-order PDCCH to PDSCH, PDSCH to HARQ-ACK, and PDCCH to PUSCH depending on UE capability considering different backhaul conditions between two TRPs. Both intra-slot separated HARQ-ACK (per TRP basis) and joint HARQ-ACK feedback (across two TRPs) can be supported and specified as by [4] for Type-1 and Type-2 HARQ-ACK codebook in order to facilitate different backhaul conditions. The maximum number of active TCI states in a serving cell can be doubled by independent activation from two TRPs but the maximum number of active TCI states per TRP remains the same as in Rel.15 NR.

With reference to detailed procedures according to Rel-16 NR, for single-DCI-based NCJT transmission, up to 8 transmission layers, each TCI code point can correspond to one or two TCI states (so as to 2-port PTRS if applicable) activated by MAC-CE. When 2 TCI states are indicated by DCI, the first TCI state corresponds to the CDM group of the first antenna port indicated by the antenna port indication table, e.g. the first TRP, and the second TCI state corresponds to the other CDM group, e.g. the second TRP. Additional new DMRS entries {0,2,3} with two CDM groups without data is supported to improve the flexibility of NCJT based scheduling.

For example, the following transmission schemes are supported with single-DCI and configured by higher layer signalling:
‘FDMSchemeA’: When two TCI states, i.e., two TRPs, are indicated in a DCI and the UE is set to ‘FDMSchemeA’, the UE receives a single PDSCH transmission occasion of the TB with each TCI state associated to a non-overlapping frequency domain resource allocation in a manner of comb-like PRGs allocation (or half/half for wideband).
‘FDMSchemeB’: When two TCI states, i.e., two TRPs, are indicated in a DCI and the UE is set to ‘FDMSchemeB’, the UE receives two PDSCH transmission occasions of the same TB with each TCI state associated to non-overlapping frequency domain resource allocation in a manner of comb-like PRGs allocation (or half/half for wideband).
‘TDMSchemeA’ (intra-slot): When two TCI states are indicated in a DCI and the UE is set to ‘TDMSchemeA’, the UE receives two PDSCH transmission occasions of the same TB with each TCI state associated to a PDSCH transmission occasion which has non-overlapping time domain resource allocation with respect to the other PDSCH transmission occasion. Both PDSCH transmission occasions corresponding to two TRPs, respectively, with mapping Type B are received within a given slot with a symbol-level gap configured by StartingSymbolOffsetK.
“repetitionNumber-r16” (inter-slot): When a UE is configured by the higher layer parameter repetitionNumber-r16 in PDSCH-TimeDomainResourceAllocation-r16, the U E may expect to be indicated with one or two TCI states in a codepoint of the TCI field. When two TCI states are indicated in a DCI, the UE may expect to receive multiple slot level PDSCH transmission occasions of the same TB with two TCI states associated to repetitionNumber-rH6 consecutive slots (up to 16). Each PDSCH transmission occasion is expected to have the same SLIV. The UE may be configured with either cyclicMapping or sequentialMapping for given TCI state mapping pattern.

Each PDSCH transmission occasion is limited to up to two transmission layers for above transmission schemes targeting at reliability improvement and indicated DMRS port(s) are expected to within one CDM group. The redundancy version for PDSCH transmission occasions associated with the second TCI state is shifted with respect to the value of rvₛ by sequenceOffsetforRV-r16 if applicable.

Additionally, default beam assumptions for FR2 are specified for receiving PDSCH, CSI-RS and PDCCH/PDSCH overlapping in case of single-DCI and multi-DCI based multi-TRP/panel transmission.

Using Rel-17 NR, there are two different operation modes for multi-TRP PDCCH: PDCCH repetition and SFN based PDCCH transmission. In both modes, the UE can receive two PDCCH transmissions, one from each TRP, carrying the same DCI. In PDCCH repetition mode, the UE can receive the two PDCCH transmissions carrying the same DCI from two linked search space sets each associated with a different CORESET. In SFN based PDCCH transmission mode, the UE can receive the two PDCCH transmissions carrying the same DCI from a single search space set/CORESET using different TCI states. For multi-TRP PUSCH repetition, according to indications in a single DCI or in a semi-static configured grant provided over RRC, the UE performs PUSCH transmission of the same contents toward two TRPs with corresponding beam directions associated with different spatial relations. For multi-TRP PUCCH repetition, the UE performs PUCCH transmission of the same contents toward two TRPs with corresponding beam directions associated with different spatial relations. For inter-cell multi-TRP operation, for multi-DCI PDSCH transmission, one or more TCI states can be associated with SSB with a PCI different from the serving cell PCI. The activated TCI states can be associated with at most one PCI different from the serving cell PCI at a time.

With reference to detailed procedures according to Rel-17 NR, PDCCH repetition is defined by explicit linkage between two search space sets. The two linked search space sets can be associated with corresponding CORESETs with different TCI states, hence, achieving beam-diversity for PDCCH transmission. In Rel-17 NR, only intra-slot PDCCH repetition is supported, and also, PDCCH repetition is only supported for USS or Type3 CSS. In addition, the linkage is specified at the PDCCH candidate level by restricting configurations of two linked search space sets resulting in one-to-one mapping between monitoring occasions and between PDCCH candidates of the two linked search space sets. Two linked PDCCH candidates have the same aggregation level, same coded bits, and the same DCI payload. To avoid ambiguity at the UE, a reference PDCCH candidate is defined for various procedures such as timelines, PUCCH resource determination, PDSCH reception with mapping Type B or mapping Type A, determination of QCL assumption for PDSCH when TCI field is not present in DCI, etc. UE can report whether the UE requires to perform two decoding operations or three decoding operations for a DCI format provided by the two linked PDCCH candidates. In the case of three decoding operations, overbooking for PDCCH receptions/DCI decoding is enhanced accordingly. Furthermore, determination of two QCL-TypeD is specified for FR2 to support time-overlapping PDCCH repetitions. PDCCH repetition is supported also for cross-carrier scheduling through linking two search space sets in both scheduling cell and scheduled cell.

For support of multi-TRP PUCCH repetition, up to two sets of power control parameters in FR1 or up to two PUCCH-SpatialRelationlnfo in FR2 can be activated per PUCCH resource or per PUCCH resource group via MAC-CE. In addition, multi-TRP PUCCH repetition can be configured by intra-slot PUCCH repetition as well as inter-slot PUCCH repetition for all PUCCH formats. Based on the number of activated PUCCH-SpatialRelationlnfo or set of power control parameters for the scheduled PUCCH resource, dynamic switching based on DCI between single-TRP PUCCH repetition and multi-TRP PUCCH repetition can be supported. Separate power control for multi-TRP PUCCH repetition is supported by two activated PUCCH-SpatialRelationInfo or two activated sets of power control parameters. Furthermore, up to two TPC fields in a DCI can be supported for a PUCCH transmission and each TPC field is applied for each corresponding index for closed loop power control state.

For support of multi-TRP PUSCH repetition, up to two SRS resource sets with usage set to ‘codebook’ or ‘nonCodebook’ can be supported. If a UE is provided two SRS resource sets with usage set to ‘codebook’ or ‘nonCodebook’, the second SRI field, second TPMI field (if CB-based PUSCH is supported), and second PTRS-DMRS association field are indicated by DCI format 0_1 or 0_2 for PUSCH transmission occasions toward the TRP that is related to the second SRS resource set with usage set to ‘codebook’ or ‘nonCodebook’ for PUSCH transmission scheduled by DCI. In addition, a DCI field defined as ‘SRS resource set indicator’ with 2 bits supports switching between single-TRP PUSCH repetition (corresponding to codepoint ‘00’ and ‘01’) and multi-TRP PUSCH repetition (corresponding to codepoint ‘10’ and ‘11’). Separate power control for multi-TRP PUSCH repetitions is supported by linking two SRI fields with two sets of power control parameters via higher layers. Up to two TPC fields for a PUSCH transmission can be supported and each TPC field is applied for a corresponding index of a closed loop power control state. Multi-TRP PUSCH repetitions are also supported for configured grant type 1 and 2.

Multi-TRP PDSCH reception is extended to inter-cell operation in Rel-17 NR. A UE can be configured with an SSB associated with a PCI that is different from the serving cell PCI and is known as additional PCI. At most 7 different additional PCIs can be configured to the UE and only one is activated at a given time for inter-cell multi-TRP operation. The additional PCI can be associated with one or more TCI states, and a gNB can schedule PDSCH from either TRP by indicating a TCI state via a field in DCI.

In order to support a HST-SFN operation, Rel-17 NR provides two approaches for frequency offset compensation: (a) UE-based and (b) TRP-based. For UE-based compensation (scheme A), the UE receives additional reference signals, such as TRS, from the TRPs in a non-SFN manner to facilitate more accurate frequency offset compensation. The corresponding non-SFN TRS configurations are provided to the UE by using two TCI states containing references to the TRS of two TRPs using DCI and MAC signalling. The TRP-based compensation (scheme B) relies on frequency offset pre-compensation at the network side, where each TRP estimates the downlink frequency by using an UL signal, e.g., SRS, and compensates the DL frequency per TRP prior to transmission. For TRP based pre-compensation, a UE also receives two TRS transmitted by the TRPs in a non-SFN manner using two TCI states. However, since network pre-compensates the PDCCH and PDSCH by the difference of the frequency offsets observed between two TRPs, frequency offset tracking at the UE is performed using only one TRS transmitted by a reference TRP.

When considering UE procedures for receiving control information and for enabling adaptation to monitor of physical downlink control channels (PDCCH) in a full-duplex wireless communication system, several issues related to limitations and drawbacks of existing technology need to be overcome.

A first issue relates to different received SINR conditions in non-SBFD slots/symbols and in SBFD slots/symbols, respectively, or in different SBFD subbands.

It needs to be considered that for transmissions by a gNB or TRP in a full-duplex system, a different number of transmitter/receiver antennas, a different effective transmitter antenna aperture area, and/or different transmitter antenna directivity settings may be available for gNB or TRP transmissions in a DL slot or symbol, i.e., non-SBFD slot or symbol, when compared to gNB or TRP transmissions in a SBFD slot or symbol. Similar considerations may apply to gNB or TRP receptions in a normal UL slot or symbol when compared to gNB or TRP receptions in the UL sub-band of a SBFD slot. The EPRE settings for gNB or TRP transmissions in a SBFD slot or symbol with full-duplex operation may be constrained to prevent gNB-side or TRP-side receiver AGC blocking and to enable effective implementation of serial interference cancellation (SIC) during gNB or TRP receptions in the UL subband of the SBFD slot or symbol when comparted to the EPRE settings of gNB or TRP transmissions in the normal DL slot. Therefore, the gNB or TRP transmission power budget and, correspondingly, the received signal strength available for the UE receiver, may not be same for a signal/channel being transmitted by the gNB or TRP on a non-SBFD slot/symbol when compared to transmission by the gNB or TRP of a same signal/channel on an SBFD slot/symbol. Similar observations hold when full-duplex transmission and reception by a gNB based on multiple antenna panels or across TRPs is implemented. QCL and transmit timing aspects may vary between different panels or TRPs. The transmissions or receptions from/by the gNB may be subjected to different link gains depending on the antenna panel used for a transmission or reception instance. Transmissions to or receptions from a same UE using different TRPs may be subjected to different link gains depending on the TRP for a transmission or reception instance. Similar observations hold for transmissions or receptions using different SBFD subbands where different link conditions may result with respect to a same UE scheduled from the gNB or across TRPs. For example, the available gNB or TRP DL Tx power budget may be more restricted in an SBFD subband when compared to another SBFD subband of the gNB or TRP. For example, a TRX configuration or an SBFD antenna configuration or an EPRE limitation(s) arising from the frequency-domain placement of the SBFD subband in the NR carrier bandwidth to ensure sufficient adjacent channel protection may be different for different TRPs.

Furthermore, interference levels experienced by the UE receiver may differ between receptions in a normal DL slot or symbol and receptions in a SBFD slot or symbol. During receptions in a normal DL slot, the UE receiver may be interfered by co-channel transmissions from neighbor gNBs or TRPs. During receptions in an SBFD slot or symbol, the UE receiver may be subjected to UE-to-UE inter-subband co-channel and/or UE-to-UE adjacent channel cross-link interference (CLI) stemming from UL-to-DL transmissions in the SBFD slot or symbol. Therefore, the resulting interference power levels and their variation experienced by the UE receiver may not be same for reception of signal/channels on non-SBFD slot/symbol when compared to reception of a signal/channel on an SBFD slot/symbol. Similar observations hold for transmissions or receptions using different SBFD subbands where different interference levels may result with respect to a same UE scheduled from the gNB or across TRP. For example, adjacent channel interference may affect a first SBFD DL subband in the upper part of the NR channel bandwidth more than a second SBFD DL subband in the lower part of the NR channel bandwidth. In another example, UE-to-UE inter-subband co-channel interference may not be symmetrical with respect to the UE actual transmission bandwidth of the aggressor UE, i.e., depend on the active UL BWP, the PUSCH transmission bandwidth allocation and UE Tx filtering. In presence of intra-cell or inter-cell TRP operation, larger variations may be expected due to non-co-location of the TRPs.

Therefore, it is beneficial for a gNB to separately control or adjust PDCCH receptions for a UE in a full-duplex system with SBFD operation for transmissions and/or receptions based on multiple TRPs.

There is a need to provide procedures for supporting separate indication for PDCCH skipping, and separate durations of PDCCH skipping, in non-SBFD slots/symbols and in SBFD slots/symbols for TRP A or TRP B or for both TRP A and TRP B. There is another need to provide procedures for supporting separate indication for SSSG switching, and separate configuration of corresponding SSSGs, in non-SBFD slots/symbols and in SBFD slots/symbols for TRP A or TRP B or for both TRP A and TRP B. There is another need to provide procedures for supporting a combination of the procedures for separate indication for PDCCH skipping and for SSSG switching in non-SBFD slots/symbols and in SBFD slots/symbols for TRP A or TRP B or for both TRP A and TRP B.

A second issue relates to the non-uniform deployment of the SBFD feature in different cells and on different frequency layers of a network and the correspondingly arising need for efficient support of PDCCH monitoring adaptation feature.

It needs to be considered that SBFD operation may not be deployed or supported by all gNBs or TRPs in the operator's TDD network. It can be expected that the availability and use of the SBFD feature in a deployment and the SBFD configuration in a cell may depend on a number of factors such as benefits, operational constraints and KPIs. Some gNBs or TRPs in the deployment grid may support SBFD but other gNBs or TRPs may not. For example, gNBs in one network segment from a first network vendor may support SBFD but gNBs in another network segment from a second network vendor may not. In another example, gNBs or TRPs on lower frequency layers of the operator's TDD network may not support SBFD operation but gNBs or TRPs of the same operator on higher frequency layers may support SBFD operation. Some but not all gNBs or TRPs of a same vendor in a network segment may implement and support SBFD operation but it may not be assumed that these gNBs or TRPs then use the same SBFD configuration in time and/or frequency domains. For example, gNBs or TRPs deployed for urban macro layer coverage by the operator may support SBFD operation using ‘DUD’ but gNBs or TRPs of the same operator deployed for indoor coverage or industrial service may use a different SBFD configurations such as ‘DU’, or none at all. A different size and location of the frequency-domain allocation for the SBFD UL subband may be configured for different gNBs or TRPs due to different available NR carrier bandwidths on the NR channels. gNBs on different frequency layers, i.e., on different NR bands, of a same operator may not operate synchronously with respect to SFN. While gNB phase synchronization and alignment of gNB transmission timing is required and de-facto necessary for TDD operation on a same NR channel and in a same NR band, gNB timing alignment for dual-connectivity including EN-DC or NR-NR DC is not always possible to achieve due to practical site and deployment constraints. TRPs deployed for intra-cell or inter-cell operation by the operator may not always allow for both DL transmissions and UL receptions to/from a UE. The SBFD feature may or may not be available on a TRP due to antenna dimensioning, antenna integration and civil engineering constraints. Some TRPs may need to configure and use a separate SBFD configuration when compared to another TRP on a same cell.

Therefore, there is need to provide solutions and procedures to separately control or adjust PDCCH receptions in a full-duplex wireless communication system to support seamless operation for a same or for different UE(s) across TRPs with and without SBFD support, and across TRPs with support for SBFD operation deployed on a same or on different frequency layers using a same or using different SBFD configuration(s).

In the present disclosure, various embodiments of enhanced PDCCH skipping for mTRP case are provided. Such embodiments may involve skipping of PDCCH monitoring for a UE by selectively enabling or disabling PDCCH reception from TRP A or from TRP B or from both TRPs in non-SBFD or in SBFD symbols or on one or more selected SBFD subbands. Associated DCI design aspects such as use of an existing, an extended, or a new PDCCH monitoring adaptation field in DCI and/or provision of RRC parameters may be implemented. Further, various embodiments of further enhanced SSSG switching for mTRP case are provided. Such embodiments may involve selective assignment of PDCCH monitoring based on SSSG with group index j for UE for TRP A or for TRP B or for both TRPs on non-SBFD or on SBFD symbols or on one or more selected SBFD subbands. Associated DCI design aspects such as use of an existing, an extended, or a new PDCCH monitoring adaptation field in DCI and/or provision of RRC parameters may be implemented. Further still, various embodiments of other enhancements for mTRP case are provided. For example, such embodiments may involve separate SSSG assignments for non-SBFD and SBFD symbols with respect to TRP A, to TRP B and/or both TRP A and TRP B such as SSSGj assigned for PDCCH monitoring on non-SBFD slot with respect to TRP A while SSSG kis used on non-SBFD slots with respect to TRP B. Joint indications of SSSG switching and PDCCH skipping for TRP A or for TRP B, or for both TRP A and TRP B, when using an extended or a new PDCCH monitoring adaptation field may be implemented.

In certain embodiments, a UE may be provided with an SBFD configuration based on a parameter sbfd-config to determine receptions and/or transmissions on a serving cell supporting full-duplex operation. For example, the UE may be provided with a set of RBs or a set of symbols for an SBFD UL or DL subband on a symbol or in a slot based on sbfd-config. For example, the UE may be provided with a set of symbols or slots for an SBFD subband based on sbfd-config. An SBFD configuration may be provided by higher layers, e.g., RRC, or may be indicated based on DCI and/or MAC-CE signaling. A combination of SBFD configuration based on higher layer parameters such as sbfd-config and indication through DCI and/or MAC-CE signaling may also be used. The UE may determine an SBFD configuration for a symbol, or a slot, or a set of symbols, or a set of slots using higher layer parameters provided for an SBFD configuration and based on reception or transmission conditions such as a slot type ‘D’, ‘U’, or ‘F’. In one example, the SBFD configuration and/or parameters associated with the SBFD configuration are same for all TRPs. In one example, the SBFD configuration and/or parameters associated with the SBFD configuration can be TRP specific following the aforementioned configuration examples.

For example, an SBFD configuration may provide a set of time-domain resources, e.g., symbols/slots, where receptions or transmissions by the UE are allowed, possible, or disallowed. An SBFD configuration may provide a range or a set of frequency-domain resources, e.g., serving cell, BWP, start and/or end or a set of RBs, where receptions or transmissions by the UE are allowed, possible, or disallowed. An SBFD configuration may provide one or multiple guard intervals or guard RBs for time and/or frequency domain radio resources during receptions or transmissions by the UE, e.g., guard SCs or RBs, guard symbols. An SBFD configuration may be provided based on one or multiple resource types such as non-SBFD symbol’ or ‘SBFD symbol’, or ‘simultaneous Tx-Rx’, ‘Rx only’, ‘Tx only’ or ‘D’, ‘U’, ‘F’, ‘N/A’. An SBFD configuration may be associated with one or multiple scheduling behaviors, e.g., for “dynamic grant”, for “configured grant”, for “any”. An SBFD configuration and/or parameters associated an SBFD configuration may include indications or values to determine Tx power settings of receptions by the UE, such as, reference power, energy per resource element (EPRE), or power offset of a designated channel/or signal type transmitted by a serving gNB; to determine the power and/or spatial settings for transmissions by the UE.

For example, a UE may be provided with an SBFD configuration to determine receptions and/or transmissions on a serving cell supporting full-duplex operation. For example, the UE may be provided with a set of RBs or a set of symbols for an SBFD UL or DL subband on a symbol or in a slot (frequency domain resources). For example, the UE may be provided with a set of symbols or slots for an SBFD subband (time domain resources). In one example, the SBFD configuration applies to all TRPs in the cell. In one example, the SBFD configurations are separately provided for each TRP in the cell. In one example, a common SBFD configuration is provided for a cell and an additional delta configuration is separately provided for each TRP in the cell, wherein the delta configuration can include additional frequency/time domain resources to be added to the common configuration and/or excluded frequency/time domain resources to be excluded from the common configuration. In one example, a common SBFD configuration is provided for a first TRP of the cell and an additional delta configuration is provided for each other TRP in the cell, wherein the delta configuration can include additional frequency/time domain resources to be added to the common configuration and/or excluded frequency/time domain resources to be excluded from the common configuration.

For example, an SBFD configuration and/or parameters associated with SBFD configuration based on sbfd-config may be provided by higher layer, e.g., RRC, or may be indicated based on DCI and/or MAC-CE signaling. A combination of SBFD configuration and/or parameterization based on higher layer parameters and indication through DCI and/or MAC-CE signaling may be used. The UE may determine an SBFD configuration for a symbol, or a slot, or a set of symbols, or a set of slots using higher layer parameters provided for an SBFD configuration and based on reception or transmission conditions such as for a slot or symbol type ‘D’, ‘U’, or ‘F or a slot or a symbol type ‘SBFD’ or ‘non-SBFD’ or for an SBFD subband type such as ‘SBFD DL subband’, ‘SBFD UL subband’, or ‘SBFD Flexible subband’.

For example, an SBFD configuration may provide a set of time-domain resources, e.g., symbols/slots, where receptions or transmissions by the UE are allowed, possible, or disallowed. In one example, the time-domain resources are same (e.g., common) for all TRPs as aforementioned. In another example, the time-domain resources can be different for each TRP, as aforementioned. An SBFD configuration may provide a range or a set of frequency-domain resources, e.g., serving cell, BWP, start and/or end or a set of RBs, where receptions or transmissions by the UE are allowed, possible, or disallowed. In one example, the frequency-domain resources are same (e.g., common) to all TRPs as aforementioned. In another example, the frequency-domain resources can be different for each TRP, as aforementioned. An SBFD configuration may provide one or multiple guard intervals or guard RBs for time and/or frequency domain radio resources during receptions or transmissions by the UE, e.g., guard SCs or RBs, guard symbols, wherein the provided SBFD configuration may be same or different for each TRP as aforementioned. An SBFD configuration may be provided based on one or multiple resource types such as non-SBFD symbol’ or ‘SBFD symbol’, or ‘simultaneous Tx-Rx’, ‘Rx only’, ‘Tx only’ or ‘D’, ‘U’, ‘F’, ‘N/A’. In one example, SBFD configuration is performed at a slot level. In one example, SBFD configuration is performed at a symbol level. In one example, SBFD configuration is performed at a slot level and symbol level. In one example, An SBFD configuration may be associated with one or multiple scheduling behaviors, e.g., for “dynamic grant”, for “configured grant”, for “any”. An SBFD configuration and/or parameters associated with an SBFD configuration may include indications or values to determine Tx power settings of receptions by the UE, such as, reference power, energy per resource element (EPRE), or power offset of a designated channel/or signal type transmitted by a serving gNB; to determine the power and/or spatial settings for transmissions by the UE.

For example, an SBFD configuration and/or parameters associated with the SBFD configuration may be provided to the UE by means of common RRC signaling using SIB, or be provided by UE-dedicated RRC signaling such as ServingCellConfig. For example, an SBFD configuration and/or parameters associated with the SBFD configuration may be provided to the UE using an RRC-configured TDRA table, or a PDCCH, PDSCH, PUCCH or PUSCH configuration, and/or DCI-based signaling that can indicate to the UE a configuration, or allow the UE to determine an SBFD configuration on a symbol or slot.

For example, the UE may be provided with information for an SBFD subband configuration such as an SBFD UL subband in one or more SBFD symbols by higher layer signaling. For example, a frequency-domain location and a size or a frequency-domain occupancy of the SBFD subband may be provided to the UE by means of indicating or assigning a start RB and an allocation bandwidth, or based on a resource indicator value (RIV), or a number of RBs, or a bitmap. An SBFD subband configuration may be provided to the UE with respect to a common resource block (CRB) grid. An SBFD subband configuration may be provided to the UE with respect to a UE BWP configuration, e.g., excluding resource blocks (RBs) in an NR carrier BW that are not within a configured or an active UE BWP. An SBFD subband configuration may be provided based on a reference RB and/or based on a reference SCS. The UE may be provided with information for an SBFD subband configuration such as an SBFD DL subband in an SBFD slot or symbol by higher layer signaling. For example, a frequency-domain location and a size or a frequency-domain occupancy of an SBFD DL subband may be provided to the UE by means of indicating or assigning a start RB and an allocation bandwidth, or an RIV value, or a number of RBs, or a bitmap, separately from a configuration provided to the UE for an SBFD UL subband. An SBFD DL subband configuration may be provided to the UE with respect to a CRB grid, or with respect to a UE BWP configuration. An SBFD DL subband configuration may be provided based on an indicated reference RB and/or based on a reference SCS. There may be multiple SBFD DL subband configurations in an SBFD symbol or slot. If multiple SBFD DL subband configurations are provided for an SBFD symbol or slot, the SBFD DL subbands may be non-contiguous. For example, two SBFD DL subband configurations may be provided to the UE for an SBFD symbol by higher layers. A same SBFD DL subband configuration or a same SBFD UL subband configuration may be provided for multiple symbols or slots, or different symbols or slots may be indicated or assigned separate SBFD DL subband and/or SBFD UL subband configurations, respectively.

For example, an SBFD configuration and/or parameters associated with the SBFD configuration for sbfd-config may be provided to the UE using tdd-UL-DL-ConfigurationCommon as example for RRC common configuration and/or tdd-UL-DL-ConfigurationDedicated as example for UE-specific configuration. The UE may determine an SBFD configuration based on a common TDD UL-DL frame configuration of a serving cell by receiving a SIB such as a SIB1 when accessing the cell from RRC_IDLE/INACTIVE, or by RRC signaling when the UE is configured with an SCell or additional SCGs by an IE ServingCellConfigCommon in RRC_CONNECTED. The UE may determine an SBFD configuration based on a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration can designate a slot or symbol as one of types ‘D’, ‘U’ or ‘F’ using at least one time-domain pattern with configurable periodicity.

In certain embodiments, a TCI state may be used for beam indication. A TCI state may refer to a DL TCI state for DL channels, e.g., PDCCH or PDSCH, an UL TCI state for UL channels, e.g., PUSCH or PUCCH, a joint TCI state for DL and UL channels, or separate TCI states for UL and DL channels or signals. A TCI state may be common across multiple component carriers, or may be a separate TCI state for a component carrier of a set of component carriers. A TCI state may be gNB or UE panel specific or common across panels. In some examples, an UL TCI state may be replaced by an SRS resource indicator (SRI).

In certain embodiments, a cell may include more than one transmission/reception point (TRP). For example, mTRP operation may be referred to as intra-cell mTRP operation. In one example, a TRP may be identified by a CORESETPOOLIndex associated with CORESETs for PDCCH receptions. In one example, a TRP may be identified by a group (e.g., one or more) SS/PBCH blocks (SSBs). For example, a first group or set of SSBs belong to or determine or identify a first TRP, a second group or set of SSBs belong to or determine or identify a second TRP, and so on. In one example, a TRP may be identified by a group (e.g., one or more) channel state information reference signal (CSI-RS) resources or CSI-RS resource sets. For example, a first group or set of CSI-RS resources or CSI-RS resource sets belong to or determine or identify a first TRP, a second group or set of CSI-RS resources or CSI-RS resource sets belong to determine or identify a second TRP, and so on. In one example, a TRP may be identified by a group (e.g., one or more) antenna ports. For example, a first group or set of antenna ports belong to or determine or identify a first TRP, a second group or set of antenna ports belong to determine or identify a second TRP, and so on. In one example, a TRP is identified or determined following one or more of the previous examples. In one example, a TRP may be identified by a group (e.g., one or more) sounding reference signal (SRS) resources or SRS resource sets. For example, a first group or set of SRS resources or SRS resource sets belong to or determine or identify a first TRP, a second group or set of SRS resources or SRS resource sets belong to or determine or identify a second TRP, and so on. In one example, a TRP may be identified by a group (e.g., one or more) TCI states (UL TCI states or DL TCI states or Joint TCI states or TCI state codepoints). For example, a first group or set of TCI states belong to or determine or identify a first TRP, a second group or set of TCI states belong to or determine or identify a second TRP, and so on. For conciseness of description, mTRP operation using TRPs associated with different CORESETPOOLIndex, or different TCI states lists are used in the following examples. As can be seen, solutions based on association of TRPs with SSBs or CSI-RS resources sets may be considered equivalent.

In certain embodiments, transmissions and/or receptions associated with more than one TRP may involve more than one cell wherein a cell is associated with a cell identifier such as a physical cell ID (PCI). For example, mTRP operation may be referred to as inter-cell mTRP operation. For example, a TRP may be identified by a CORESETPOOLIndex, by a group or set (e.g., one or more) of SSBs, by a group or set (e.g., one or more) of CSI-RS resources or resource sets, by a group or set (e.g., one or more) of SRS resources or resource sets, or by a group or set (e.g., one or more) of TCI states such as exemplified for intra-cell mTRP. For example, a UE may be configured with an SSB associated with a PCI which is different from the serving cell PCI, known as additional PCI. For example, an additional PCI can be associated with one or more TCI states, and a gNB can schedule a DL or UL channel or signal from either TRP by indicating a corresponding TCI state via a TCI field in DCI.

In certain embodiments, a different number of TRXs, a different effective transmitter antenna aperture area, and/or different transmitter antenna directivity settings may be available for transmissions from TRP A to a UE in a slot or symbol, when compared to TRP B transmissions in a slot or symbol, and/or a different number of TRXs, a different effective reception antenna aperture area, and/or different reception antenna directivity settings may be available for receptions by the TRP A of transmissions from a UE in a slot or symbol, when compared to TRP B receptions in a slot or symbol.

For conciseness of the descriptions and for illustration purposes, the following example mTRP cases with respect to the provided, e.g., configured and/or indicated SBFD configurations to the UE may be considered in the disclosure. A same or a different SBFD configurations provided to the UE for transmissions/receptions to/from TRP A and TRP, respectively, may apply on a symbol, a slot, or a duration.
Case 1: TRP A and TRP B support the SBFD feature and are provided with a same SBFD configuration;
Case 2: TRP A and TRP B support the SBFD feature but are provided with different SBFD configurations;
   Case 2a: TRPA A and TRP B are provided with a same frequency-domain SBFD configuration but are provided with different SBFD time-domain configurations;
   Case 2b: TRPA A and TRP B are provided with different frequency-domain SBFD configurations but are provided with a same SBFD time-domain configuration;
   Case 2c: TRPA A and TRP B are provide with different frequency-domain SBFD configurations and are provided with different SBFD time-domain configurations;
Case 3: TRP A supports the SBFD feature, but TRP B does not support the SBFD feature, e.g., corresponding to mTRP-SBFD Case 2c where no SBFD configuration is provided for TRP B.

For example, when a same time- and frequency-domain SBFD configuration of a TRP A and a TRP B is provided to the UE by higher layers, e.g., Case 1, for a duration, including the case where the duration is not explicitly limited, e.g., such as until reception by the UE of another higher layer parameter re-configuring parts or all of the SBFD configuration for TRP A and/or TRP B or such as until a higher layer configuration is released, the UE may be provided with different time- and/or frequency-domain SBFD configurations, respectively, at a later instant, e.g., Cases 2a/2b/2c, for TRP A and TRP B.

For example, when a same time- and frequency-domain SBFD configuration of a TRP A and a TRP B is provided to the UE by higher layers, e.g., Case 1, but DCI-based or MAC-CE signaling to the UE indicates another usage of the transmission/reception direction for a higher layer provided SBFD configuration on a symbol/slot or for an SBFD subband, different time- and frequency-domain SBFD configuration on a symbol or slot of TRP A and TRP B respectively, can apply, e.g., Cases 2a/2b/2c.

For example, when different time-domain and/or frequency-domain SBFD configurations of a TRP A and a TRP B are provided to the UE by higher layers, e.g., Case 2c, but DCI-based or MAC-CE signaling to the UE indicates another usage of the transmission/reception direction for a higher layer provided SBFD configuration on a symbol/slot or for an SBFD subband, a same time-domain and/or frequency-domain SBFD configuration on a symbol or slot of TRP A and TRP B respectively, can apply, e.g., Case 1.

For example, when a same or different time-domain and/or frequency-domain SBFD configurations of a TRP A and a TRP B are provided to the UE by higher layers, e.g., Case 1/2a/2b/2c, but DCI-based or MAC-CE signaling to the UE indicates another usage of the transmission/reception direction for a higher layer provided SBFD configuration on a symbol/slot or for an SBFD subband, no SBFD configuration may be available, e.g., Case 3.

In one embodiment, a UE is provided by higher layers from a serving gNB a new parameter, for example PDCCHSkippingDurationList-rxx, that enables or disables PDCCH reception from TRP A, or from TRP B, or from TRP A and TRP B based on a slot or symbol type or based on an SBFD subband type in a duration. For example, a slot or symbol type may correspond to ‘SBFD’ or ‘non-SBFD’, or ‘D’ or ‘F’, or ‘D and F’. For example, an SBFD subband type may correspond to an SBFD DL subband, an SBFD UL subband, or an SBFD flexible subband. For example, PDCCHSkippingDurationList-rxx can include separate sets of PDCCH skipping durations for SBFD symbols/slots or for non-SBFD symbols/slots or for SBFD subbands with respect to receptions from TRP A, or from TRP B, or from TRP A and TRP B.

In one example, the UE is provided by higher layers a set of four PDCCH skipping durations d1, d2, d3 and d4. PDCCH skipping duration d1 is associated with no PDCCH skipping for either TRP A or TRP B. PDCCH skipping duration d2 is associated with PDCCH skipping on SBFD symbols for TRP A only, e.g., d2=40 (or 40 slots for SCS=30 kHz), but no PDCCH skipping for TRP B. PDCCH skipping duration d3 is associated with PDCCH skipping on non-SBFD symbols for TRP B only, e.g., d3=20 (or 20 slots for SCS=30 kHz), but no PDCCH skipping for TRP A. PDCCH skipping duration d4 is associated with PDCCH skipping on SBFD symbols for TRP A and on non-SBFD symbols for TRP B, respectively, e.g., d4=120 (or 120 slots for SCS=30 kHz). The UE can be provided with a set of indication values associated with the set of higher-layer PDCCH skipping durations d1, d2, d3 and d4, e.g., using codepoints ‘00’, ‘01’, ‘01’ and ‘11’ for an indication of PDCCH skipping durations d1, d2, d3 and d4, respectively. For example, a two-bit field of a DCI can be used to signal an indication of a higher layer PDCCH skipping duration to the UE. For example, the UE is provided with parameter coresetPoolIndex which has a value 0 for a first CORESET, e.g., associated with TRP A, and has a value 1 for a second CORESET, e.g., associated with TRP B.

When the UE is indicated to use PDCCH skipping duration d1, the UE monitors PDCCH receptions from both TRP A on the first CORESET and TRP B on the second CORESET on both SBFD and non-SBFD symbols according to parameters such as monitoringSlotPeriodicityAndOffset provided by higher-layer PDCCH configuration. When the UE is indicated to use PDCCH skipping duration d2, the UE skips PDCCH receptions from TRP A on the first CORESET for the duration d2 on the SBFD symbols but not on the non-SBFD symbols, and the UE monitors PDCCH reception from TRP B on the second CORESET on both SBFD and non-SBFD symbols according to parameters such as monitoringSlotPeriodicityAndOffset provided by higher-layer PDCCH configuration. When the UE is indicated to use PDCCH skipping duration d3, the UE skips PDCCH receptions from TRP B on the second CORESET for the duration d3 on the non-SBFD symbols but not on the SBFD symbols and the UE monitors PDCCH reception from TRP A on the first CORESET on both SBFD and non-SBFD symbols according to parameters such as monitoringSlotPeriodicityAndOffset provided by higher-layer PDCCH configuration. When the UE is indicated to use PDCCH skipping duration d4, the UE skips PDCCH receptions from TRP A on SBFD symbols but monitors PDCCH reception on the non-SBFD symbols on the first CORESET and the UE skips PDCCH reception from TRP B on non-SBFD symbols but monitors PDCCH reception on the SBFD symbols on the second CORESET for the duration d4.

In another example, the UE is provided by higher layer a set of four PDCCH skipping durations d1, d2, d3 and d4. PDCCH skipping duration d1 is associated with no PDCCH skipping for either TRP A or TRP B. PDCCH skipping duration d2 is associated with PDCCH skipping on SBFD DL subband 1 for TRP A only, e.g., d2=40 (or 40 slots for SCS=30 kHz), but no PDCCH skipping for TRP B. PDCCH skipping duration d3 is associated with PDCCH skipping on the SBFD UL subband for TRP B only, e.g., d3=20 (or 20 slots for SCS=30 kHz), but no PDCCH skipping for TRP A. PDCCH skipping duration d4 is associated with PDCCH skipping on SBFD DL subband 2 for TRP A and PDCCH skipping on SBFD DL subband 2 and the SBFD UL subband for TRP B, e.g., d4=120 (or 120 slots for SCS=30 kHz). For example, the second CORESET is configured for the UE such that some of the RBs of the second CORESET are comprised within the SBFD UL subband.

When the UE is indicated to use PDCCH skipping duration d1, the UE monitors PDCCH receptions from both TRP A on the first CORESET and from TRP B on the second CORESET on any SBFD subband according to parameters such as monitoringSlotPeriodicityAndOffset provided by higher-layer PDCCH configuration. When the UE is indicated to use PDCCH skipping duration d2, the UE skips PDCCH receptions from TRP A on the first CORESET for the duration d2 on the SBFD DL subband 1 but not on SBFD DL subband 2 and not on the SBFD UL subband and the UE monitors PDCCH reception from TRP B on the second CORESET on any SBFD subband according to parameters such as monitoringSlotPeriodicityAndOffset provided by higher-layer PDCCH configuration. When the UE is indicated to use PDCCH skipping duration d3, the UE skips PDCCH receptions on the second CORESET for the duration d3 on the SBFD UL subband but not on SBFD DL subbands 1 and 2 for TRP B and the UE monitors PDCCH reception on the first CORESET on any SBFD subband for TRP A according to parameters such as monitoringSlotPeriodicityAndOffset provided by higher-layer PDCCH configuration. When the UE is indicated to use PDCCH skipping duration d4, the UE skips PDCCH receptions on the first CORESET for the duration d4 on the SBFD DL subband 2 but not on the SBFD DL subband 1 and not on the SBFD UL subband for TRP A and the UE skips PDCCH receptions on the second CORESET for the duration d4 on the SBFD UL subband and on the SBFD DL subband 2 but not the SBFD DL subband 1.

Considering the existence of SBFD and non-SBFD resources and of a first TRP and a second TRP, a field of more than 2 bits, such as a field of 4 bits or 6 bits, can provide flexible indication per TRP and per resource type for a number of PDCCH skipping durations and, the larger a number of bits for the field, the larger the number of PDCCH skipping durations that can be indicated per TRP and per resource type (SBFD or non-SBFD). A mapping of values to PDCCH skipping durations for combinations of {SBFD, non-SBFD} resources and of {TRP A, TRP B} can be defined where the combinations can be indicated by higher layers. For example, a first combination can be {SBFD, TRP A, TRP B} a second combination can be {non-SBFD, TRP A, TRP B}, a third combination can be {SBFD, non-SBFD, TRP A}, a fourth combination can be {SBFD, non-SBFD, TRP A, TRP B}, and so on. A same combination can be mapped to multiple values of the field associated with different PDCCH skipping durations for the combination. It is also possible that a DCI format includes two fields; a first indicating a PDCCH monitoring duration on SBFD resources for both TRP A and TRP B, and a second indicating a PDCCH monitoring duration on non-SBFD resources for both TRP A and TRP B. It is also possible that a DCI format includes four fields; a first indicating a PDCCH monitoring duration on SBFD resources for TRP A, a second indicating a PDCCH monitoring duration on non-SBFD resources for TRP A, a third indicating a PDCCH monitoring duration on SBFD resources for TRP B, and a fourth indicating a PDCCH monitoring duration on non-SBFD resources for TRP B.

In another embodiment, a UE is provided by higher layers from a serving gNB a new parameter PDCCHSkippingDurationList-rxx that selectively enables or disables PDCCH reception from TRP A, or from TRP B, or from TRP A and TRP B in a duration that is applicable only for ‘SBFD’ or ‘F’ slot or symbol types, is not applicable to ‘non-SBFD’ or ‘D’ slot or symbol types, and includes a set of PDCCH skipping durations for receptions from TRP A, or from TRP B, or from TRP A and TRP B (that is applicable only for SBFD symbols/slots). For other types of slots or symbols, such as non-SBFD slots or symbols, a legacy PDCCHSkippingDurationList parameter can be used to provide a set of durations for PDCCH skipping. It is also possible that PDCCHSkippingDurationList-rxx is used to provide a set of durations for PDCCH skipping for both non-SBFD time or frequency resources and for SBFD time or frequency resources. For brevity, the following descriptions consider that the legacy parameter is used for non-SBFD time or frequency resources.

For example, when a UE is provided by higher layers from a serving gNB a new parameter, for example PDCCHSkippingDurationList-rxx, that enables or disables PDCCH reception from TRP A, or from TRP B, or from TRP A and TRP B for PDCCH skipping, a codepoint in a DCI field of size N, e.g., N=4 bits, can indicate one or more of:
The TRP or TRPs to skip (e.g., TRP A and/or TRP B);
The symbol (or slot) types to skip (e.g., SBFD and/or non-SBFD slots);
The SBFD configurations to skip;
The type of SBFD sub-band to skip (e.g., SBFD DL subband and/or SBFD UL subband and/or first SBFD DL subband and/or second SBFD DL subband and/or SBFD flexible subband);
The duration of skipping, wherein the duration can be in units of slots or symbols or sub-frames or frames.

An indication value associated with PDCCHSkippingDurationList-rxx for receptions from TRP A, or from TRP B, or from TRP A and TRP B, may be provided to the UE using a unicast DCI such as DCI format 0_1/0_2/1_1/1_2 in [2]. The indication can be based on an existing PDCCH monitoring adaptation field, or an extended PDCCH monitoring adaptation field with additional bits, or a new field at least in case that the set of durations provided by PDCCHSkippingDurationList-rxx is applicable only to SBFD symbols or slots or to SBFD subbands with respect to receptions from TRP A or from TRP B, or from TRP A and TRP B. The functionality of a PDCCH monitoring adaptation field for PDCCH skipping for receptions on SBFD or non-SBFD symbols or on SBFD subbands from TRP A or from TRP B, or from TRP A and TRP B, can also be applicable for a multicast DCI, for a PDCCH associated with multicast DCI formats, such as DCI format 4_0/4_1 in [2]. A predetermined value of the PDCCH monitoring adaptation field may also disable PDCCH monitoring from TRP A or from TRP B or from TRP A and TRP B indefinitely until a same value or a different value toggles the PDCCH monitoring from TRP A or from TRP B or from TRP A and TRP B, respectively to be enabled. In that manner, ON/OFF M-TRP operation for PDCCH monitoring on SBFD or non-SFBD symbols or on SBFD subbands can be supported via a DCI format and can also be differentiated for SBFD time resources and non-SBFD time resources (symbols or slots) or for SBFD frequency resources (SBFD subbands).

For example, when a single PDCCH monitoring adaptation field is used, a value of the field can map both to a PDCCH skipping duration value from the set of PDCCH monitoring duration values for non-SBFD symbols/slots, and to a PDCCH skipping duration value from the set of PDCCH monitoring duration values for SBFD symbols/slots, such as a second value from the two sets of durations. A duration may be associated with skipping receptions from TRP A or from TRP B, or from TRP A and TRP B. For example, when a PDCCH monitoring adaptation field of size M=2 bits is configured for a UE in a DCI with respective PDCCH monitoring on a serving cell, and the set of durations provided to the UE by PDCCHSkippingDurationList or by PDCCHSkippingDurationList-rxx includes three values, a value ‘00’ indicates no PDCCH skipping, and values ‘01’/‘10’/‘11’ respectively indicate PDCCH skipping for a first/second/third duration from PDCCHSkippingDurationList in non-SBFD symbols/slots and for a first/second/third duration from PDCCHSkippingDurationList-rxx in SBFD symbols/slots on the active DL BWP of the serving cell with respect to receptions from TRP A or from TRP B, or from TRP A and TRP B. For example, a second value from the two sets of durations may be associated with PDCCH skipping on an SBFD subband on an SBFD symbol/slot.

For example, when an extended PDCCH monitoring adaptation field with additional bits is used, first bits of the field can indicate a first PDCCH skipping duration value for non-SBFD symbols/slots, and second bits of the field can indicate a second PDCCH skipping duration value for SBFD symbols/slots or an SBFD subband with respect to receptions from TRP A or from TRP B, or from TRP A and TRP B. For example, when two PDCCH monitoring adaptation fields are provided by DCI, a first field can indicate a first PDCCH skipping duration value for non-SBFD symbols/slots with respect to receptions from a reference or a default TRP, and the second field can indicate a second PDCCH skipping duration value for SBFD symbols/slots or an SBFD subband with respect to receptions from TRP A or from TRP B, or from TRP A and TRP B. The first field can be an existing field and the second field can be a new field or both the first and second fields can be new fields.

For example, when an extended PDCCH monitoring adaptation field of size M=4 bits is configured for a UE in a DCI with respective PDCCH monitoring on a serving cell, and the set of durations provided to the UE by PDCCHSkippingDurationList or by PDCCHSkippingDurationList-rxx includes three values, a value ‘00’ for the first two bits of the M=4 bits of the field indicates no PDCCH skipping and values ‘01’/‘10’/‘11’ respectively indicate PDCCH skipping for a first/second/third duration from PDCCHSkippingDurationList in non-SBFD symbols/slots with respect to a reference or a default TRP, e.g., TRP A, while a value ‘00’ for the last two bits of the M=4 bits of the field indicates no PDCCH skipping and values ‘01’/‘10’/‘11’ respectively indicate PDCCH skipping for a first/second/third duration from PDCCHSkippingDurationList-rxx in SBFD symbols/slots or on an SBFD subband on the active DL BWP of the serving cell with respect to TRP B.

For example, when an extended PDCCH monitoring adaptation field of size M=3 bits is configured for a UE in a DCI with respective PDCCH monitoring on a serving cell, and the set of durations provided to the UE by PDCCHSkippingDurationList includes one value and the set of durations provided to the UE by PDCCHSkippingDurationList-rxx includes three values, a value ‘0’ for the first bit of the M=3 bits of the field indicates no PDCCH skipping and a value ‘1’ indicates PDCCH skipping for (a first) duration from PDCCHSkippingDurationList in non-SBFD symbols/slots with respect to a reference or a default TRP, e.g., TRP A, a value ‘00’ for the last two bits of the M=3 bits of the field indicates no PDCCH skipping with respect to TRP B, and values ‘01’/‘10’/‘11’ respectively indicate PDCCH skipping for a first/second/third duration from PDCCHSkippingDurationList-rxx in SBFD symbols/slots or on an SBFD subband on the active DL BWP of the serving cell with respect to both TRP A and TRP B. Similar procedures can apply if instead of bits from an extended PDCCH monitoring adaptation field, a new/additional PDCCH monitoring adaptation field is used to indicate a PDCCH skipping duration from PDCCHSkippingDurationList-rxx in SBFD symbols/slots or on an SBFD subband with respect to receptions from TRP A or from TRP B, or from TRP A and TRP B.

In the following, parameter PDCCHSkippingDurationList-rxx can provide a first set of PDCCH skipping durations for non-SBFD symbols/slot and a second set of PDCCH skipping durations for SBFD symbols/slots or SBFD subbands, or can provide only a set of PDCCH skipping durations for SBFD symbols/slots or SBFD subbands while a legacy parameter PDCCHSkippingDurationList provides a set of PDCCH skipping durations for non-SBFD symbols/slots with respect to receptions from TRP A or from TRP B or from TRP A and TRP B.

A PDCCH monitoring adaptation field in a DCI can be any of:
a legacy PDCCH monitoring adaptation field with a value that maps to more than one sets of values for respective more than one sets of durations for skipping PDCCH monitoring for TRP A or for TRP B, or for TRP A and TRP B, where the more than one sets of durations are associated with non-SBFD slots and SBFD slots, or with an SBFD DL subband or an SBFD UL subband, or an SBFD flexible subband. The value may be applicable to both non-SBFD slots/symbols and SBFD slots/symbols, or may be applicable only to slots/symbols of same type as the slot/symbols of the PDCCH reception with the DCI. One of TRP A or TRP B may be a reference or a default TRP associated with PDCCH receptions on a serving cell;
an extended PDCCH monitoring adaptation field, possibly with a number of bits that is larger than in case of non-full-duplex operation, where first bits from the number of bits provide a first value that maps to a first duration for skipping PDCCH monitoring in non-SBFD slots and second bits from the number of bits provide a second value that maps to a second duration for skipping PDCCH monitoring in SBFD slots with respect to receptions from TRP A or from TRP B, or from TRP A and TRP B. In similar manner, second bits from the number of bits may provide a second value that maps to a second duration for skipping PDCCH monitoring in an SBFD DL subband, or an SBFD UL subband, or an SBFD flexible subband with respect to receptions from TRP A or from TRP B, or from TRP A and TRP B. The first and second durations can be from a same set of durations or from separately provided sets of durations. In that latter case, a number of first bits and a number of second bits can be different and be determined from a size of a corresponding set of durations. One of TRP A or TRP B may be a reference or a default TRP associated with PDCCH receptions on a serving cell;
a new PDCCH monitoring adaptation field that is applicable to SBFD slots or symbols, or to PDCCH receptions in a configured or indicated SBFD DL subband, SBFD UL subband, or SBFD flexible subband, with respect to receptions from TRP A or from TRP B, or from both TRP A and TRP B, while a legacy PDCCH monitoring adaptation field, or another new PDCCH monitoring adaptation field, is applicable to non-SBFD slots or symbols, or to PDCCH receptions in an SBFD DL subband, or an SBFD UL subband, or an SBFD flexible subband from a reference or default TRP associated with PDCCH receptions on a serving cell. A first number of bits for the legacy PDCCH monitoring adaptation field, or a for first new PDCCH monitoring field, can be different from a second number of bits for the new PDCCH monitoring adaptation field, or for the second new PDCCH monitoring field, where the first and second numbers of bits can be determined from the sizes of corresponding sets of durations. One of TRP A or TRP B may be a reference or a default TRP associated with PDCCH receptions on a serving cell.

In another embodiment, an indication to enable or disable PDCCH reception in a duration from TRP A or from TRP B, or from both TRP A and TRP B, based on a slot or symbol type, or based on an SBFD subband type, may be provided to the UE by an association with a slot or symbol type, or by an association with an SBFD subband type, where the UE receives such an indication. Therefore, an interpretation by the UE for an applicability of a PDCCH monitoring adaptation field in a DCI format can be for types of symbols or slots or types of SBFD subbands, such as non-SBFD or SBFD, that are same as a type of symbols or slots or subbands where the UE received a PDCCH that provided the DCI format, and the indication by the PDCCH monitoring adaptation field in the DCI format is not applicable for PDCCH monitoring in symbols or slots or SBFD subbands of different types.

For example, the UE can be provided with parameter coresetPoolIndex which has a value 0 for a first CORESET, e.g., associated with TRP A, configured in a first SBFD DL subband, and has a value 1 for a second CORESET, e.g., associated with TRP B, configured in a second SBFD DL subband. The UE enables or disables subsequent PDCCH receptions on the first SBFD DL subband with respect to TRP A for a duration when the DCI format with the PDCCH monitoring adaptation field is received on the first CORESET. The UE enables or disables subsequent PDCCH reception on the second SBFD DL subband with respect to TRP B for a duration when the DCI format with the PDCCH monitoring adaptation field is received on the second CORESET. In case of PDCCH repetitions, PDCCH receptions from TRP A or from TRP B or from both TRP A and TRP B on either the first or the second or on both CORESETs can be enabled or disabled.

For example, a UE that is provided PDCCHSkippingDurationList-rxx may be indicated a duration through PDCCH monitoring adaptation field value in a DCI for the UE to skip PDCCH receptions in SBFD slots/symbols but not to skip PDCCH receptions in non-SBFD slots/symbols with respect to receptions from TRP A or from TRP B, or from TRP A and TRP B. In another example, a UE that is provided PDCCHSkippingDurationList-rxx may be indicated a duration through an indication value in a DCI for the UE to skip PDCCH receptions in slots/symbols of type ‘F’ configured or indicated with an SBFD subband but not to skip PDCCH receptions in slots/symbols of type ‘D’ configured or indicated with an SBFD subband with respect to receptions from TRP A or from TRP B, or from TRP A and TRP B.

For example, a UE that is provided PDCCHSkippingDurationList-rxx that includes a set of PDCCH skipping durations, may be indicated a duration from the set of PDCCH skipping durations through a value of a PDCCH monitoring adaptation field in a DCI, for example as previously described, for skipping PDCCH receptions from TRP A or from TRP B or from TRP A and B, respectively, on non-SBFD or SBFD symbols or on an SBFD subband when respective PDCCH monitoring occasions coincide or at least partially overlap on symbols with a selected and designated symbol type or SBFD subband type, and PDCCH receptions are not skipped otherwise with respect to receptions from TRP A or from TRP B, or from TRP A and TRP B. In another example, the gNB may configure the UE to skip PDCCH receptions when corresponding PDCCH monitoring occasions overlap with an SBFD flexible subband but to not skip PDCCH receptions when corresponding PDCCH monitoring occasions are within an SBFD DL or UL subband with respect to receptions from TRP A or from TRP B, or from TRP A and TRP B.

For example, a UE that is provided PDCCHSkippingDurationList-rxx may be indicated a duration, through a value of a PDCCH monitoring adaptation field in a DCI, for the UE to skip PDCCH receptions for a slot type or symbol type where the UE receives the PDCCH providing the DCI, but the UE does not skip PDCCH receptions for another slot type or symbol type with respect to receptions from TRP A or from TRP B, or from TRP A and TRP B. For example, the UE is provided with parameter coresetPoolIndex which has a value 0 for a first CORESET, e.g., associated with TRP A, and has a value 1 for a second CORESET, e.g., associated with TRP B. In an example, TRP A transmits to the UE on the first CORESET a PDCCH with a DCI that includes a PDCCH monitoring adaptation field on an SFBD symbol or slot where a value of the field, e.g., a codepoint of the field, indicates a duration for PDCCH skipping from the set of durations. The UE then skips PDCCH receptions from TRP A for the duration on symbols with same type as the symbols where the UE received the PDCCH, e.g., on SBFD symbols, and the UE does not skip PDCCH reception from TRP A for the duration on other symbol types, e.g., non-SBFD symbols. The UE does not skip PDCCH reception behavior with respect to TRP B. In another example, the TRP A transmits to the UE a PDCCH on the first CORESET with a DCI that includes a PDCCH monitoring adaptation field on a flexible symbol/slot where a value of the field, e.g., codepoint of the field, indicates a duration for PDCCH skipping from the set of durations. The UE then skips PDCCH reception from TRP A and TRB, for the duration on symbols with same type as the symbols where the UE received the PDCCH, e.g., flexible symbols, and does not skip PDCCH receptions from TRP A and TRP B for the duration on other symbol types, e.g., DL symbols. A motivation is reception of a single PDCCH can disable PDCCH reception on a symbol type interfered by inter-UE CLI. Separate behavior for PDCCH skipping when a DCI is received on symbol type ‘D’ and ‘F’, respectively, can be configured by higher layers if desired. The duration can correspond to all types of symbols or slots or to only the associated type of symbols or slots and separate durations can be associated with TRP A and TRP B, respectively. For example, when the duration is in terms of slots and has a value of 20 slots for a TRP, the 20 slots can be any slots, or can be only slots PDCCH receptions are according to SBFD (or non-SBFD) operation. For example, when the duration is a set of durations in terms of slots and has a value of a pair of 20 and 40 slots, the 20 slots can be any slots for TRP A, and 40 slots for TRP B.

Similar solutions as described may be used for indication to a UE to skip PDCCH receptions from TRP A or from TRP B or from TRP A and TRP B, respectively, in an SBFD subband type that is same as an SBFD subband type where the UE receives the PDCCH that includes a DCI with the indication for PDCCH skipping for receptions from TRP A or from a TRP B, or from TRP A and B. For example, TRP A transmits to the UE a PDCCH on the first CORESET that includes a DCI with a PDCCH monitoring adaptation field on an SBFD flexible subband, e.g., where an SBFD flexible subband allows for the possibilities of transmissions from the UE or for receptions by the UE with respect to receptions from or transmissions to TRP A, or TRP B, or TRP A and TRP B. The indication by the PDCCH monitoring adaptation field, e.g., the codepoint of the field indicates PDCCH skipping for a duration from the applicable set or durations for TRP A or for TRP B or for both TRP A and TRP B. The UE then skips PDCCH receptions for the duration on the SBFD subband for TRP A or for TRP B or for both TRP A and TRP B where the UE received the PDCCH with the DCI, e.g., SBFD flexible subband, and does not skip PDCCH receptions for the duration in other subband types, e.g., SBFD DL subbands.

A motivation for enabling different UE behaviors, including different durations, for PDCCH skipping in non-SBFD symbols or slots and in SBFD symbols or slots with respect to receptions from TRP A, or from TRP B, or TRP A and TRP B is increased link robustness when operating on a serving cell supporting full-duplex operation in presence of multiple TRPs. By selectively enabling or disabling PDCCH monitoring based on a slot/symbol type, or based on an SBFD subband type, using PDCCHSkippingDurationList-rxx, a gNB can adjust the PDCCH monitoring based on DCI indication for a UE to a subset of time-domain or frequency-domain resources corresponding to the SBFD configurations associated with TRP A and TRP B, respectively, and can enable the UE to save power by not monitoring PDCCH in remaining time-domain or frequency-domain resources of the SBFD configurations particularly when a result is that the UE does not monitor PDCCH over at least a few milliseconds, such as more than 3-4 milliseconds.

For example, PDCCHSkippingDurationList-rxx for TRP A, or for TRP B, or for TRP A and TRP B, or for an SBFD subband may be included in one or more RRC messages and/or IEs and a parameter PDCCHSkippingDurationList-rxx may be received by the UE based on a system information block (SIB), such as a SIB1, or by a common RRC signaling, or by UE-specific RRC signaling. For example, and without loss of generality, PDCCHSkippingDurationList-rxx may be provided by the gNB to the UE as part of RRC messages of type RRCSetup, RRCReconfiguration, SIB1 or SystemInformation, or may be included in RRC IEs of type ServingCellConfig, ServingCellConfigCommon, or ServingCellConfigSIBL. Such RRC configuration parameters may be of enumerated, listed or sequence type or may be encoded as a bit string. In one example, PDCCHSkippingDurationList-rxx may be included in an IE of type PDCCH-Config. Multiple parameter sets for PDCCHSkippingDurationList-rxx may be provided to the UE.

For example, the UE may be provided a set or list of skipping durations for PDCCH monitoring by PDCCHSkippingDurationList-rxx. A set or a group of serving cells may be associated with a PDCCHSkippingDurationList-rxx. A value for a skipping duration may be associated with or be defined with reference to an SCS, such as an SCS of an active DL BWP or of a reference DL BWP, or with reference to a reference SCS such as 15 kHz, or in terms or absolute time such as milliseconds. A value from the values of skipping durations can correspond to a default duration or to a remaining of a DRX on-duration. PDCCHSkippingDurationList-rxx may include a different allowed set of skipping durations, or a larger maximum allowed value, than SCS-SpecificDuration-r17, e.g., larger than 200 in units of slots or 100 msec for SCS=30 kHz.

A UE may be provided PDCCHSkippingDurationList-rxx for TRP A, or for TRP B, or for TRP A and TRP B, or for an SBFD subband that includes multiple sets of PDCCH monitoring durations where a set may be associated to one or more of:
a slot or symbol type, e.g., ‘SBFD’ or ‘non-SBFD’, or ‘D’ or ‘F’ or ‘D and F’, or
an SBFD subband type, e.g., SBFD DL subband, SBFD UL subband, or SBFD flexible subband type, or
an SBFD subband type associated with a slot or symbol type such as ‘D’ or ‘F’.

PDCCHSkippingDurationList-rxx can indicate slot/symbol indices or a set of slots/symbols where a UE skips or does not skip PDCCH receptions for TRP A, or for TRP B, or for TRP A and TRP B, or for an SBFD subband for a duration. The UE may be provided time-domain resources, e.g., slots/symbols, where the UE skips or does not skip PDCCH receptions for TRP A, or for TRP B, or for TRP A and TRP B, or for an SBFD subband for a duration even when the UE determines that a slot/symbol or a slot/symbol type where a PDCCH reception may occur is part of a PDCCH configuration, e.g., associated with a PDCCH monitoring occasion. For example, PDCCHSkippingDurationList-rxx for TRP A, or for TRP B, or for TRP A and TRP B, or for an SBFD subband can indicate presence or absence of PDCCH monitoring over a subset of slots/symbols in a set of slots/symbols of a DL-UL frame configuration with period p for TRP A, or for TRP B, or for TRP A and TRP B, or for an SBFD subband. For example, the UE may be provided a list or sequence or bitmap representative of M slots/symbols from the set of N slots/symbols in a period p for TRP A, or for TRP B, or for TRP A and TRP B, or for an SBFD subband. A UE may determine for PDCCH monitoring a subset of M slots/symbols from the set of N slots/symbols. For example, the UE may determine the first or the last M slots/symbols from a set of N slots/symbols as a subset. For example, M may be 1 or M may be associated with default values. Multiple subsets of slots/symbols may be provided to the UE or be determined by the UE for TRP A, or for TRP B, or for TRP A and TRP B, or for an SBFD subband.

PDCCHSkippingDurationList-rxx for TRP A, or for TRP B, or for TRP A and TRP B, or for an SBFD subband may include a bitmap to indicate time-domain resources, such as based on an RRC parameter monitoringSlotsWithinSlotGroup or monitoringSymbolsWithinSlot, or frequency-domain resources based on an RRC parameter freqMonitorLocations for PDCCH monitoring. PDCCHSkippingDurationList-rxx for TRP A, or for TRP B, or for TRP A and TRP B, or for an SBFD subband may be associated with PDCCH monitoring using a CCE aggregation level, such as for example for a UE to skip PDCCH receptions with an indicated CCE aggregation level, such as 8, for an indicated duration. PDCCHSkippingDurationList-rxx may be associated with a resource type indication for skipping PDCCH receptions, such as a slot or symbol or symbol group of a radio resource that may be of type ‘simultaneous Tx-Rx’, ‘Rx only’, or ‘Tx only’. For example, a resource type indication such as ‘simultaneous Tx-Rx’, ‘Rx only’, or ‘Tx only’ can be provided per slot type ‘D’, ‘U’ or ‘F’ in a slot or symbol. For example, a resource type may be associated with a configured or an indicated SBFD UL and/or DL subband. An indication of the resource type may be provided independently of the transmission direction of a slot or symbol indicated to the UE by the TDD UL-DL frame configuration provided by higher layers.

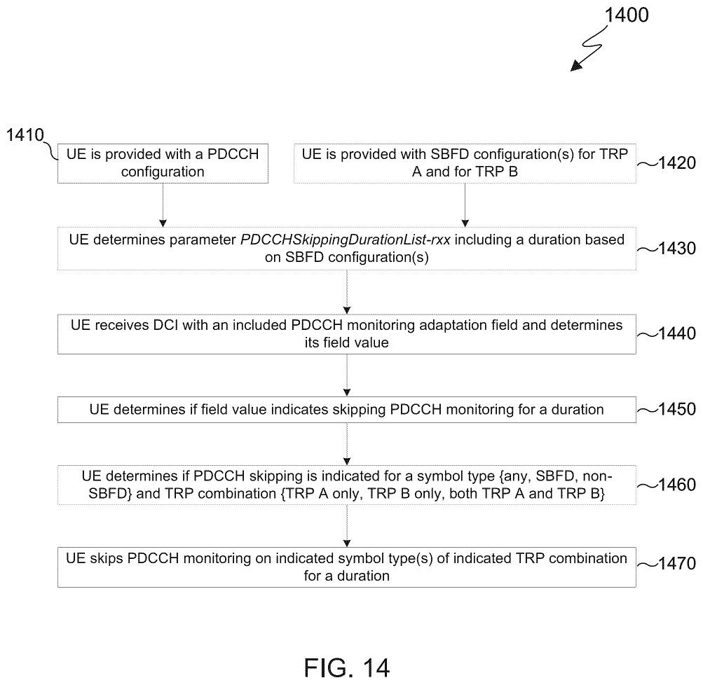

FIG. 14 illustrates a flowchart of an example process 1400 of PDCCH skipping for subband full duplex (SBFD)/non-SBFD symbol types based on provided SBFD configuration(s) per TRP in a FD communication system according to embodiments of the present disclosure. The process 1400 of FIG. 14 can be performed by any of the UEs 111-116 of FIG. 1, such as the UE 116 of FIG. 3. The process 1400 is for illustration only and other embodiments can be used without departing from the scope of the present disclosure.

The process 1400 begins with the UE being provided with PDCCH configuration (1410). The UE is also provided with SBFD configurations for TRP A and TRP B (1420). The UE then determines a parameter PDCCHSkippingDurationList-rxx based on the PDCCH configuration and based on the SBFD configurations for TRP A and TRP B (1430). The UE then receives a DCI that provides a PDCCH monitoring adaptation field and determines a field value (1440). The UE then determines if the field value indicates PDCCH skipping for a duration (1450). If the UE determines that a PDCCH skipping duration is indicated by the field value, the UE further determines if a PDCCH skipping duration is indicated for one or a combination of symbol type {SBFD, non-SBFD} and for one or a combination of TRPs for PDCCH receptions from {TRP A only, TRP B only, TRP A and TRP B}(1460). The UE then applies the indicated PDCCH skipping durations to the indicated symbol types and the indicated TRPs (1470).

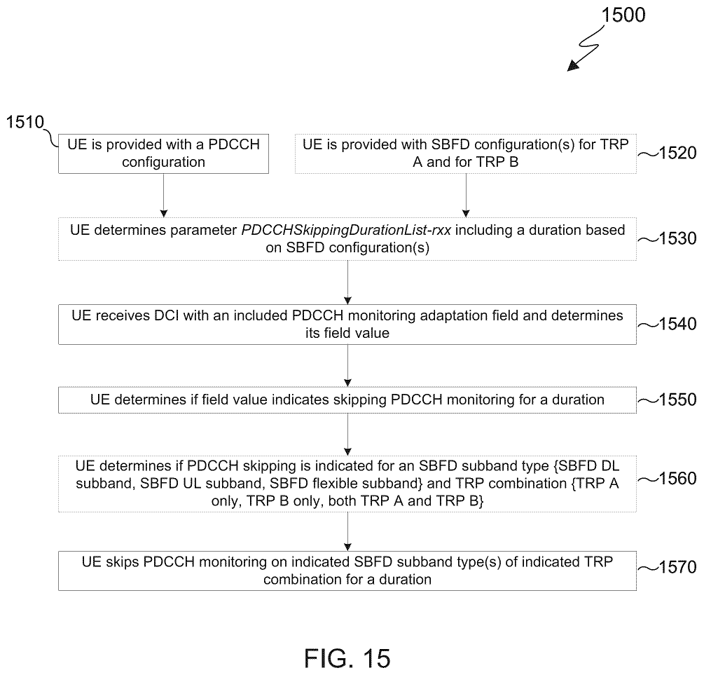

FIG. 15 illustrates a flowchart of an example process 1500 of PDCCH skipping for SBFD subband types based on provided SBFD configuration(s) per TRP in a FD communication system according to embodiments of the present disclosure. The process 1500 of FIG. 15 can be performed by any of the UEs 111-116 of FIG. 1, such as the UE 116 of FIG. 3. The process 1500 is for illustration only and other embodiments can be used without departing from the scope of the present disclosure.

The process 1500 begins with the UE being provided with a PDCCH configuration (1510). The UE is also provided with SBFD configurations for TRP A and TRP B (1520). The UE then determines a parameter PDCCHSkippingDurationList-rxx based on the PDCCH configuration and based on the SBFD configurations for TRP A and TRP B (1530). The UE then receives a DCI with an included PDCCH monitoring adaptation field and determines its field value (1540). The UE then determines if the field value indicates PDCCH skipping for a duration (1550). If the UE determines that a PDCCH skipping duration is indicated by the field value, the UE further determines if a PDCCH skipping duration is indicated for one or a combination of SBFD subband type {SBFD DL subband, SBFD UL subband, SBFD flexible subband} and for one or a combination of TRP for PDCCH receptions from {TRP A only, TRP B only, TRP A and TRP B}(1560). The UE then applies the indicated PDCCH skipping durations to the indicated SBFD subband types and the indicated TRPs (1570).

In one embodiment, the UE is provided by higher layers from a serving gNB a new parameter searchSpaceGroupIdList-rxx that assigns a SSSG for PDCCH monitoring for receptions from TRP A, or from TRP B, or from TRP A and TRP B, based on a slot or symbol type or based on an SBFD subband type. For example, a slot or symbol type may correspond to ‘SBFD’ or ‘non-SBFD’, or ‘D’ or ‘F’, or ‘D and F’. For example, an SBFD subband type may correspond to an SBFD DL subband, an SBFD UL subband, or an SBFD flexible subband.

In one example, the UE is provided by higher layer a set of three SSSG with group index a1, a2 and a3 for PDCCH monitoring from TRP A. Use of SSSG with group index a1 results in monitoring on non-SBFD symbols from TRP A. Use of SSSG with group index a2 results in monitoring on SBFD symbols from TRP A. Use of SSSG with group index a1 results in monitoring on SBFD and non-SBFD symbols from TRP A. The UE is provided by higher layer a set of three SSSG with group index b1, b2 and b3 for PDCCH monitoring from TRP B. Use of SSSG with group index b1 results in monitoring on non-SBFD symbols from TRP B. Use of SSSG with group index b2 results in monitoring on SBFD symbols from TRP B. Use of SSSG with group index b1 results in monitoring on SBFD and non-SBFD symbols from TRP B. The UE can be provided with a set of indication values associated with the sets of SSSG assignments a1-a3 and/or b1-b3 for TRP A and TRP B, e.g., using a two-bit field with four codepoints ‘00’, ‘01’, ‘01’ and ‘11’ in a DCI. For example, codepoint ‘00’ indicates start of PDCCH monitoring according to SSSG with index a1 from TRP A and index b1 from TRP B, codepoint ‘01’ indicates start of PDCCH monitoring according to SSSG with index a1 from TRP A and index b2 from TRP B, codepoint ‘10’ indicates start of PDCCH monitoring according to SSSG with index a2 from TRP A and index b2 from TRP B, codepoint ‘11’ indicates start of PDCCH monitoring according to SSSG with index a3 from TRP A and index b1 from TRP B. The UE is provided with parameter coresetPoolIndex which has a value 0 for a first CORESET, e.g., associated with TRP A, and has a value 1 for a second CORESET, e.g., associated with TRP B.

When the UE is indicated codepoint ‘00’, the UE starts PDCCH monitoring according to an SSSG with group index a1 for TRP A, e.g., on non-SBFD symbols, and stops PDCCH monitoring according to an SSSG with another group index of TRP A. The UE starts PDCCH monitoring according to an SSSG with group index b1 for TRP B, e.g., on non-SBFD symbols, and stops PDCCH monitoring according to an SSSG with another group index of TRP B.

When the UE is indicated codepoint ‘01’, the UE starts PDCCH monitoring according to an SSSG with group index a1 for TRP A, e.g., on non-SBFD symbols, and stops PDCCH monitoring according to an SSSG with another group index of TRP A. The UE starts PDCCH monitoring according to an SSSG with group index b2 for TRP B, e.g., on SBFD symbols, and stops PDCCH monitoring according to an SSSG with another group index of TRP B.

When the UE is indicated codepoint ‘10’, the UE starts PDCCH monitoring according to an SSSG with group index a2 for TRP A, e.g., on SBFD symbols, and stops PDCCH monitoring according to an SSSG with another group index of TRP A. The UE starts PDCCH monitoring according to an SSSG with group index b2 for TRP B, e.g., on SBFD symbols, and stops PDCCH monitoring according to an SSSG with another group index of TRP B.

When the UE is indicated codepoint ‘11’, the UE starts PDCCH monitoring according to an SSSG with group index a3 for TRP A, e.g., on non-SBFD and SBFD symbols, and stops PDCCH monitoring according to an SSSG with another group index of TRP A. The UE starts PDCCH monitoring according to an SSSG with group index b1 for TRP B, e.g., on non-SBFD symbols, and stops PDCCH monitoring according to an SSSG with another group index of TRP B.

Above example can be extended to cases where per-TRP indication of PDCCH monitoring according to an SSSG with group index j for an SBFD subband type is desired. For example, when the UE is indicated codepoint ‘11’, the UE starts PDCCH monitoring according to an SSSG with group index a3 for TRP A on SBFD DL subband 1 on non-SBFD symbols only, and stops PDCCH monitoring according to an SSSG with another group index of TRP A. The UE starts PDCCH monitoring according to an SSSG with group index b1 for TRP B on SBFD UL subband of SBFD symbols, e.g., on non-SBFD symbols, and stops PDCCH monitoring according to an SSSG with another group index of TRP B.

Considering the existence of SBFD and non-SBFD resources and of a first TRP and a second TRP, a field of more than 2 bits, such as a field of 4 bits or 6 bits, can provide flexible indication per TRP and per resource type for SSSGs and, the larger a number of bits for the field, the larger the number of SSSGs that can be indicated per TRP and per resource type (SBFD or non-SBFD). A mapping of values to SSSGs for combinations of {SBFD, non-SBFD} resources and of {TRP A, TRP B} can be defined where the combinations can be indicated by higher layers. For example, a first combination can be {SBFD, TRP A, TRP B} a second combination can be {non-SBFD, TRP A, TRP B}, a third combination can be {SBFD, non-SBFD, TRP A}, a fourth combination can be {SBFD, non-SBFD, TRP A, TRP B}, and so on. A same combination can be mapped to multiple values of the field associated with different SSSGs for the combination. It is also possible that a DCI format includes two fields; a first indicating an SSSG on SBFD resources for both TRP A and TRP B, and a second indicating an SSSG on non-SBFD resources for both TRP A and TRP B. It is also possible that a DCI format includes four fields; a first indicating an SSSG on SBFD resources for TRP A, a second indicating an SSSG on non-SBFD resources for TRP A, a third indicating an SSSG on SBFD resources for TRP B, and a fourth indicating an SSSG on non-SBFD resources for TRP B.

For example, when a UE is provided by higher layers from a serving gNB a new parameter searchSpaceGroupIdList-rxx that assigns a SSSG for PDCCH monitoring for receptions from TRP A, or from TRP B, or from TRP A and TRP B, a codepoint in a DCI field of size N, e.g., N=4 bits, can indicate one or more of:
For each TRP, the symbol or slot type(s) (e.g., SBFD and/or non-SBFD slots) to skip or to monitor;
For each TRP, the SBFD configurations to skip or to monitor;
For each TRP, the type of SBFD subband to skip or to monitor (e.g., SBFD DL subband and/or SBFD UL subband and/or first SBFD DL subband and/or second SBFD DL sub-band and/or SBFD flexible sub-band).

In another embodiment, a UE is provided by higher layers from a serving gNB a new parameter searchSpaceGroupIdList-rxx that assigns a SSSG for PDCCH monitoring from TRP A or from TRP B or from TRP A and TRP B only for ‘SBFD’ or ‘F’ slot or symbol types or for an SBFD UL subband or an SBFD flexible subband. For other types of slots or symbols, such as non-SBFD slots or symbols, a legacy searchSpaceGroupIdList parameter is used to selectively assign a SSSG for PDCCH monitoring. It is also possible that searchSpaceGroupIdList-rxx is used to provide SSSGs for PDCCH monitoring for both non-SBFD time or frequency resources and for SBFD time or frequency resources and, individually, for both TRP A and TRB B. For brevity, the following descriptions consider that the legacy parameter is used for non-SBFD time or frequency resources.

Parameter searchSpaceGroupIdList-rxx for PDCCH monitoring based on an SSSG may be associated with a duration, a trigger, or a fallback condition with respect to receptions from TRP A, or from TRP B, or from TRP A and TRP B. A duration or a trigger condition may be provided per TRP, e.g., for TRP A or TRP B, respectively, or may be applicable to both TRP A and TRP B. A duration or a trigger condition may be applicable to SBFD or non-SBFD symbols, respectively, or to different SBFD subband types, respectively. A fallback condition may be applied based on slot/symbol type or SBFD subband type of a same TRP or from TRP A to TRP B. For example, separate fallback conditions may be provided for the case that a UE monitors PDCCH based on an SSSG with group index j1 on an SBFD slot/symbol of TRP A to another SSSG with group index k1 on non-SBFD symbols for TRP A, or for the case that a UE monitors PDCCH based on an SSSG with group index j1 on an SBFD slot/symbol of TRP A to another SSSG with group index k1 on TRP B, or for the case that a UE monitors PDCCH based on an SSSG with group indices j1/k1 on SBFD slot/symbols of TRP A and TRP B respectively, to another SSSG with group index 11 on non-SBFD symbols on TRP A.

An indication value associated with searchSpaceGroupIdList-rxx for receptions from TRP A, or from TRP B, or from TRP A and TRP B may be provided to the UE using a unicast DCI such as DCI format 0_1/0_2/1_1/1_2 in [2] and [3]. The indication can be based on an existing PDCCH monitoring adaptation field, or an extended PDCCH monitoring adaptation field with additional bits, or a new field at least in case that an SSSG for PDCCH monitoring provided by searchSpaceGroupIdList-rxx is applicable only to SBFD symbols or slots or SBFD subbands with respect to receptions from TRP A, or from TRP B, or from TRP A and TRP B. The functionality of a PDCCH monitoring adaptation field for SSSG switching with respect to receptions from TRP A, or from TRP B, or from TRP A and TRP B can also be applicable for a multicast DCI, for SSSGs associated with multicast DCI formats, such as DCI format 4_0/4_1 in [2].

For example, when an existing PDCCH monitoring adaptation field is used for receptions from TRP A, or from TRP B, or from TRP A and TRP B, a first value of the field can assign a SSSG from the set of SSSGs for PDCCH monitoring on non-SBFD symbols/slots for a default or a reference TRP, e.g., indicate start of PDCCH monitoring according to an SSSG with group index j and stop of PDCCH monitoring according to an SSSG with another group index of TRP A, and a second value of the field can assign a SSSG from the set of SSSGs for PDCCH monitoring on SBFD symbols/slots of TRP A, or of TRP B, or of TRP A and TRP B. For example, when an existing PDCCH monitoring adaptation field of size M=2 bits is configured for a UE in a DCI with respective PDCCH monitoring on a serving cell, and the set of SSSGs provided to the UE by searchSpaceGroupIdList or by searchSpaceGroupIdList-rxx includes three SSSGs, a value ‘00’/‘01’/‘10’ respectively indicates a first/second/third SSSG from searchSpaceGroupIdList in non-SBFD symbols/slots for a reference or default TRP, e.g., TRP A and a first/second/third SSSG from searchSpaceGroupIdList-rxx in SBFD symbols/slots for PDCCH monitoring on the active DL BWP of the serving cell for receptions from TRP A, TRP B, or from TRP A and TRP B. One of TRP A or TRP B can be a reference or a default TRP.

For example, when an extended PDCCH monitoring adaptation field of size M=4 bits is configured for a UE in a DCI with respective PDCCH monitoring on a serving cell for receptions from TRP A, or from TRP B, or from TRP A and TRP B, and the set of SSSGs provided to the UE by searchSpaceGroupIdList or by searchSpaceGroupIdList-rxx includes three SSSGs, a value ‘00’/‘01’/‘10’ for the first two bits respectively indicates a first/second/third SSSG from searchSpaceGroupIdList for PDCCH monitoring in non-SBFD symbols/slots from a reference or default TRP, e.g., TRP A, and a value of ‘00’/‘01’/‘10’ for the last two bits respectively indicates a first/second/third SSSG from searchSpaceGroupIdList-rxx for PDCCH monitoring in SBFD symbols/slots on the active DL BWP of the serving cell for receptions from TRP A or from TRP B or from TRP A and B. Different combinations of SSSGs with index k1 of TRP A and index j1 of TRP B may be indicated. For example, when an extended PDCCH monitoring adaptation field of sizeM=3 bits is configured for a UE in a DCI with respective PDCCH monitoring on a serving cell for receptions from TRP A, or from TRP B, or from TRP A and B, and the set of SSSGs provided to the UE by searchSpaceGroupIdList includes two SSSGs for the default or reference TRP A and the set of SSSGs provided to the UE by PDCCHSkippingDurationList-rxx includes three SSSGs for TRP A, or for TRP B, or for TRP A and TRP B, a value ‘0’/‘1’ for the first bit of the M=3 bits of the field respectively indicates a first/second/third SSSG from searchSpaceGroupIdList for PDCCH monitoring in non-SBFD symbols/slots from the reference or default TRP A and a value of ‘00’/‘01’/‘10’ for the last two bits respectively indicates a first/second/third SSSG from searchSpaceGroupIdList-rxx for PDCCH monitoring in SBFD symbols/slots on the active DL BWP of the serving cell for receptions from TRP A or from TRP or from TRP A and TRP B. Similar procedures apply if instead of bits from an extended PDCCH monitoring adaptation field, a new/additional PDCCH monitoring adaptation field is used to indicate a SSSG from searchSpaceGroupIdList-rxx in SBFD symbols/slots with respect to receptions from TRP A or from TRP B or from TRP A and TRP B.

In the following, parameter searchSpaceGroupIdList-rxx can assign an SSSG from a first set of SSSGs for PDCCH monitoring for non-SBFD symbols/slot for TRP A, or for TRP B, or for TRP A and TRP B and an SSSG from a second set of SSSGs for PDCCH monitoring for SBFD symbols/slots for TRP A, or for TRP B, or for TRP A and TRP B, or can assign only an SSSG from a second set of SSSGs for PDCCH monitoring for SBFD symbols/slots while a legacy parameter searchSpaceGroupIdList can assign an SSSG from a first set of SSSGs for PDCCH monitoring for non-SBFD symbols/slots with respect to receptions from TRP A, or for TRP B, or for TRP A and TRP B.

A PDCCH monitoring adaptation field in a DCI can be any of:
a legacy PDCCH monitoring adaptation field with at least one value that maps to an assigned set from a set of SSSGs for PDCCH monitoring for TRP A, or for TRP B, or for TRP A and TRP B that is associated with non-SBFD slots and SBFD slots or with SBFD DL subbands or SBFD UL subbands or SBFD flexible subbands. The value may be applicable to both non-SBFD slots/symbols and SBFD slots/symbols or may be applicable only to slots/symbols of same type as the slot/symbols of the PDCCH reception with the DCI. The value may be used to assign a combination of SSSGs with index k for receptions from TRP A and index j1 for receptions from TRP B, respectively, in non-SBFD or SBFD symbols or on SBFD subbands. One of TRP A or TRP B may be a reference or a default TRP associated with PDCCH receptions on a serving cell;
an extended PDCCH monitoring adaptation field, possibly with a number of bits that is larger than in case of non-full-duplex/legacy operation, where first bits from the number of bits provide a first value that maps to an SSSG from a first set of SSSGs for PDCCH monitoring in non-SBFD slots by a reference or a default TRP and second bits from the number of bits provide a second value that maps to an SSSG from a second set of SSSGs for PDCCH monitoring in SBFD slots with respect to receptions from TRP A or from TRP B or from TRP A and TRP B. In similar manner, second bits from the number of bits may provide a second value that maps to an SSSG from a second set of SSSGs for PDCCH monitoring in SBFD DL subbands or SBFD UL subbands or SBFD flexible subbands. The first and second set of SSSGs can be from a same set of SSSGs or from separately provided SSSGs sets. Second bits may be used to assign a combination of SSSGs with index k for receptions from TRP A and index j1 for receptions from TRP B, respectively, in non-SBFD or SBFD symbols or on SBFD subbands. One of TRP A or TRP B may be a reference or a default TRP associated with PDCCH receptions on a serving cell;
a new PDCCH monitoring adaptation field that is applicable to SBFD slots or symbols, or to PDCCH receptions in a configured or indicated SBFD UL subband or SBFD flexible subband with respect to receptions from TRP A, or from TRP B, or from both TRP A and TRP B, while a legacy PDCCH monitoring adaptation field is applicable to non-SBFD slots or symbols, or to PDCCH receptions in SBFD DL subbands with respect to a reference or default TRP. One of TRP A or TRP B may be a reference or a default TRP associated with PDCCH receptions on a serving cell.

In another embodiment, an indication to selectively assign an SSSG for PDCCH monitoring based on a slot or symbol type or based on an SBFD subband type with respect to receptions from TRP A, or from TRP B, or from both TRP A and TRP B may be provided to the UE by association with a slot or symbol type or by association with an SBFD subband type, where the UE receives a PDCCH that includes a DCI format with the indication. Therefore, an interpretation by the UE for an applicability of a PDCCH monitoring adaptation field in a DCI format can be for types of symbols or slots or type of SBFD subbands, such as non-SBFD or SBFD, that are same as a type of symbols or slots or SBFD subbands of a TRP where the UE received a PDCCH that provided the DCI format and the indication by the PDCCH monitoring adaptation field in the DCI format is not applicable for PDCCH monitoring in symbols or slots or SBFD subbands of different types of the TRP.

When searchSpaceGroupIdList-rxx selectively assigns a SSSG for PDCCH monitoring for a TRP A or TRP B or for TRP A and TRP B based on a slot or symbol type, or based on a SBFD subband type, an indication value provided to the UE may be associated with more than one SSSG. For example, an indication value may be associated with an entry to searchSpaceGroupIdList-rxx that simultaneously assigns a first SSSG to a first slot/symbol type or SBFD subband type of TRP A, or TRP B, or TRP A and TRP B and a second SSSG to a second slot/symbol type or SBFD subband type of TRP A, or TRP B, or TRP A and TRP B for PDCCH monitoring by the UE. An indication value may be used to assign a combination of SSSGs with index k1 for receptions from TRP A and index j1 for receptions from TRP B, respectively, in non-SBFD or SBFD symbols or on SBFD subbands.

When searchSpaceGroupIdList-rxx assigns a SSSG for PDCCH monitoring for a TRP A or TRP B or for TRP A and TRP B only for SBFD symbols or slots, or only for SBFD subbands, a legacy field (or first bits of an extended legacy field) for an indication value of a legacy RRC parameter searchSpaceGroupIdList may be used for a first type of slots or symbols or SBFD subbands, such as non-SBFD slots or symbols or SBFD DL subbands, for a reference or default TRP and a new field (or second bits of an extended legacy field) for an indication value or RRC parameter searchSpaceGroupIdList-rxx may be used for a second type of slots or symbols or SBFD subbands, such as SBFD slots or symbols or SBFD UL subband or SBFD flexible subband with respect to receptions from TRP A or from TRP B or for TRP A and TRP B.

A UE may be indicated and/or assigned different SSSGs for PDCCH monitoring in different slot or symbol types, such as SBFD or non-SBFD symbols or slots, or in different SBFD subband types, such as SBFD or non-SBFD subbands with respect to TRP A or TRP B or TRP A and TRP B, where PDCCH reception is configured for the UE. For example, a SSSG with group index 0 may be assigned to a UE for PDCCH monitoring on non-SBFD symbols of TRP A while a SSSG with group index 1 may be assigned to the UE on SBFD symbols of TRP B.

An indication for SSSG switching to a designated SSSG, or a fallback to a default SSSG after counter expiry, when monitoring a PDCCH on a first slot/symbol type or on a first SBFD subband type may be provided to the UE concurrently or separately from an indication for SSSG switching or a fallback to a default SSSG for a second slot/symbol type or a second SBFD subband type for receptions from TRP A or from TRP B or from TRP A and TRP B. Further, separate switching delays P_{SWITCH} symbols may apply for SSSG switching on different slot/symbol types or for different SBFD subband types of TRP A or TRP B due to potentially different corresponding UE receiver requirements. For example, separate timer or counter values for a searchSpaceSwitchTimer may be provided to the UE for TRP A and TRP B or for a first and a second SBFD subband type, respectively, or separate corresponding variable counts may be maintained by the UE when monitoring PDCCH for separate slot/symbol types or for separate SBFD subband types with respect to receptions from TRP A or from TRP B or from TRP A and TRP B, respectively. For example, for a same RRC timer value provided by searchSpaceSwitchTimer to a UE for PDCCH monitoring on non-SBFD and on SBFD symbols with respect to receptions from TRP A or from TRP B or from TRP A and TRP B, respectively, the UE may determine that the timer expires earlier on SBFD symbols of TRP A than on non-SBFD symbols of TRP B when monitoring PDCCH on the serving cell for receptions from TRP A when the UE detects fewer DCI formats on the SBFD symbols of TRP A, e.g., the UE resets the associated timer value fewer times. Correspondingly, the UE may fall back to a default SSSG with group index 0 for PDCCH monitoring on non-SBFD symbols of TRP B.

For example, when a UE is provided an SBFD time-domain configuration or an SBFD subband configuration on a symbol/slot by the gNB for a TRP A or for a TRP B, the UE determines and/or applies a selected SSSG for PDCCH monitoring for an indicated slot or symbol type or for an indicated SBFD subband type of TRP A or TRP B, respectively. For example, a UE may expect to monitor PDCCH based on SSSG group index 0 on a SBFD symbol/slot of TRP A when the UE is provided with an SBFD subband configuration or when an SBFD subband configuration is re-configured for the UE for TRP A. Alternatively, the SSSG group index for PDCCH monitoring upon SBFD (re-)configuration may be provided to a UE for TRP A or for TRP B. For example, a UE may expect to reset PDCCH monitoring based on SSSG group index 0 on a non-SBFD symbol/slot of TRP A and/or TRP B when the UE is indicated another SBFD time-domain or SBFD subband configuration or when an SBFD subband configuration is re-configured by higher layers for the UE with respect to receptions from TRP A or TRP B. Alternatively, the SSSG group index for PDCCH monitoring in non-SBFD slot/symbols upon SBFD (re-)configuration of TRP A or TRP B may be provided to a UE.

For example, a UE that is provided searchSpaceGroupIdList-rxx may be selectively assigned an SSSG for PDCCH monitoring for TRP A or for TRP B for an SBFD slot/symbol through an indication value of a PDCCH monitoring adaptation field in a DCI. In another example, a UE that is provided searchSpaceGroupIdList-rxx may be selectively assigned an SSSG for PDCCH monitoring for a TRP A or a TRP B through an indication value in a DCI for a slot or/symbol of type ‘F’. For example, a UE that is provided searchSpaceGroupIdList-rxx may be selectively assigned a first SSSG with group index n1 for PDCCH monitoring for a TRP A or for a TRP B through an indication value of the PDCCH monitoring adaptation field in a DCI for PDCCH monitoring in a slot/symbol of type ‘D’ and a second SSSG with group index n2 for PDCCH monitoring of the TRP in a slot/symbol of type ‘F’.

For example, a UE that is provided searchSpaceGroupIdList-rxx may be selectively assigned an SSSG for PDCCH monitoring through an indication value of a PDCCH monitoring adaptation field in a DCI that allows or disallows PDCCH monitoring on a symbol with respect to receptions from TRP A or from TRP B, or from TRP A and TRP B where a PDCCH reception includes (at least partially) a selected or a designated SBFD subband type configured for the UE on the symbol of the TRP. The UE attempts to receive a PDCCH based on an assigned SSSG for the TRP when no SBFD subband is configured on symbols of PDCCH receptions, or when another SBFD subband type is configured on those symbols. In an example, searchSpaceGroupIdList-rxx may indicate to a UE that PDCCH monitoring by the UE for a SSSG with group index n1 is disabled when a PDCCH monitoring occasion coincides with an SBFD UL subband, and the UE monitors PDCCH based on the SSSG with group index n1 when PDCCH monitoring occasions are contained in an SBFD DL subband with respect to receptions from TRP A or from TRP B. In another example, searchSpaceGroupIdList-rxx may indicate to a UE to not monitor PDCCH based on SSSG with group index n1 on a symbol when coinciding with an SBFD flexible subband on the symbol but to monitor PDCCH using SSSG n1 when the symbol is configured with an SBFD DL subband with respect to receptions from TRP A and TRP B and instead monitor PDCCH based on SSSG with group index n2.

For example, a UE that is provided searchSpaceGroupIdList-rxx may be selectively assigned an SSSG for PDCCH monitoring for TRP A or for TRP B, or for TRP A and TRP B, through an indication value of a PDCCH monitoring adaptation field in a DCI for a slot or symbol type where the UE received the PDCCH providing the DCI, but the assignment does not apply to SSSGs for PDCCH monitoring in another slot type or symbol type. In an example, the UE receives PDCCH associated with reception from TRP A with a DCI containing a PDCCH monitoring adaptation field on an SFBD symbol or slot and the field value or codepoint of the field is associated with a change in the assigned SSSG to an SSSG with group index n1 for the TRP A. The UE then re-configures PDCCH monitoring to the SSSG with group index n1 for the symbol type or slot type on which the UE received the PDCCH with the DCI for the TRP A, e.g., an SBFD symbol, but the UE does not re-configure PDCCH monitoring using an SSSG with group index n2 on another symbol type, e.g., non-SBFD symbol, for the TRP A or for TRP B. In another example, the UE receives a DCI with a PDCCH monitoring adaptation field for TRP A on a flexible symbol or slot where the indicated field value or codepoint of the field is associated with a change in the assigned SSSG to an SSSG with group index n1. The UE then starts PDCCH monitoring using SSSG with group index n1 for the symbol type on TRP A where the UE received the PDCCH providing the DCI, e.g., flexible symbols, but the UE does not start PDCCH monitoring based on the indicated SSSG with group index n1 for another symbol type, e.g., SBFD DL symbols of TRP A, or for TRP B, where PDCCH monitoring based on another SSSG with another group index may be performed by the UE.

Similar solutions as described may be used for indication to selectively assign an SSSG for PDCCH monitoring for receptions from TRP A or from TRP B, or from TRP A and TRP B, that is the same as an SBFD subband type where the UE receives a PDCCH that includes a DCI with the indication for SSSG switching. For example, the gNB transmits to the UE a PDCCH from TRP A that includes a DCI with a PDCCH monitoring adaptation field on an SBFD flexible subband, e.g., where an SBFD flexible subband allows for the possibilities for transmissions from the UE or for receptions by the UE with respect to the TRP A. The indication by the PDCCH monitoring adaptation field, e.g., the codepoint of the field, indicates to the UE to start PDCCH monitoring using SSSG with group index n2 (and stop monitoring PDCCH using another SSSG) on TRP A. The UE then starts monitoring PDCCH based on SSSG n2 on the SBFD subband for TRP A where the UE received the PDCCH with the DCI, e.g., flexible subband, and the UE does not apply the indication in other SBFD subband types of TRP A, e.g., SBFD DL subbands, or for TRP B.

A motivation for enabling different UE behaviors for SSSG switching in SBFD symbols or slots or subbands and in non-SBFD symbols or slots with respect to receptions from TRP A or from TRP B, or TRP A and TRP B, is increased link robustness when operating on a serving cell supporting full-duplex operation in presence of multiple TRPs. By selectively assigning an SSSG for PDCCH monitoring based on a slot/symbol type, or based on an SBFD subband type, using searchSpaceGroupIdList-rxx, the gNB can dynamically restrict the PDCCH monitoring by a UE to a subset of time-domain or frequency-domain resources for the SBFD configurations associated with TRP A or TRP B. For example, the gNB may adjust the PDCCH monitoring by the UE to occur in SBFD DL subbands where the UE may experience less inter-UE CLI than in an SBFD flexible subband. The gNB can also separately adapt the search space sets used for scheduling, such as number of PDCCH candidates per CCE aggregation level or a PDCCH monitoring periodicity, based on the received SINR conditions at the UE in SBFD symbols/slots which can vary differently, such as more frequently, than the received SINR conditions in non-SBFD symbols/slots, or based on the amount of UL traffic the UE has remaining.

For example, searchSpaceGroupIdList-rxx for TRP A or for TRP B or for TRP A and TRP B or for an SBFD subband may be included in one or more RRC messages and/or IEs and searchSpaceGroupIdList-rxx may be received by the UE based on a system information block (SIB), such as a SIB1, or by a common RRC signaling, or by UE-specific RRC signaling. For example, and without loss of generality, such information may be provided by the gNB to the UE as part of RRC messages of type RRCSetup, RRCReconfiguration, SIB1 or SystemInformation, or may be included in RRC IEs of type ServingCellConfig, ServingCellConfigCommon, or ServingCellConfigSIBL. Such RRC configuration parameters may be of enumerated, listed or sequence type or may be encoded as a bit string. In one example, the parameter indicating searchSpaceGroupIdList-rxx may be included in an IE of type PDCCH-Config. Multiple parameter sets for searchSpaceGroupIdList-rxx may be provided to the UE.

For example, the UE may be provided a set or list of switching timers and/or switching delays as part of searchSpaceGroupIdList-rxx. A set or a group of serving cells may also be associated with searchSpaceGroupIdList-rxx. A value for a switching duration, or a value for a switching delay, may be associated with or be defined with reference to an SCS, such as an SCS of an active DL BWP on the serving cell or a reference SCS such as 15 kHz or in absolute time such as in milliseconds, and may use a default timer or a default delay value. Parameter searchSpaceGroupIdList-rxx may include a different allowed set of switching timer values or a larger maximum allowed switching timer value than SCS-SpecificDuration-r17, e.g., larger than 200 in units of slots or 100 msec for SCS=30 kHz.

A UE may be provided searchSpaceGroupIdList-rxx for TRP A, or for TRP B, or for TRP A and TRP B or for an SBFD subband that includes at least one set of SSSGs for PDCCH monitoring where a set may be associated to one or more of:
a slot or symbol type, e.g., ‘SBFD’ or ‘non-SBFD’, or ‘D’ or ‘F’ or ‘D and F’, or
an SBFD subband type, e.g., SBFD DL subband, SBFD UL subband, or SBFD flexible subband type, or
an SBFD subband type associated with a slot or symbol type such as ‘D’ or ‘F’.

A UE may be indicated by searchSpaceGroupIdList-rxx slot/symbol indices or a set of slots/symbols where PDCCH monitoring based on an SSSG for TRP A, or for TRP B, or for TRP A and TRP B, or for an SBFD subband is expected or not expected. The UE may be provided with time-domain resources, e.g., slots/symbols, for the UE to determine when PDCCH monitoring for TRP A, or for TRP B, or for TRP A and TRP B, or for an SBFD subband based on an SSSG from the UE is expected or not expected in a duration. For example, a UE may be indicated by searchSpaceGroupIdList-rxx a subset of slots/symbols in the set of slots/symbols of a DL-UL frame configuration of a period p for PDCCH monitoring for TRP A, or for TRP B, or for TRP A and TRP B, or for an SBFD subband. For example, the UE may be provided a list or sequence or bitmap representative of M slots/symbols from the set of N slots/symbols in a period p for TRP A, or for TRP B, or for TRP A and TRP B, or for an SBFD subband. A UE may determine a subset of M slots/symbols from the set of N slots/symbols. For example, the UE may determine the first or the last M slots/symbols from a set of N slots/symbols as a subset. For example, M may be 1 or M may be associated with default values. Multiple subsets of slots/symbols may be provided to the UE or be determined by the UE for TRP A, or for TRP B, or for TRP A and TRP B, or for an SBFD subband.

searchSpaceGroupIdList-rxx for TRP A, or for TRP B, or for TRP A and TRP B, or for an SBFD subband may include a bitmap to indicate a time-domain resource such as based on an RRC parameter monitoringSlotsWithinSlotGroup or monitoringSymbolsWithinSlot or a frequency-domain resource based on an RRC parameter freqMonitorLocations. searchSpaceGroupIdList-rxx to selectively assign PDCCH monitoring for TRP A or for TRP B or for TRP A and TRP B or for an SBFD subband based on an SSSG may be associated with a resource type indication that a slot or symbol or symbol group of a radio resource may be of type ‘simultaneous Tx-Rx’, ‘Rx only’, or ‘Tx only’. For example, a resource type indication such as ‘simultaneous Tx-Rx’, ‘Rx only’, or ‘Tx only’ can be provided per slot type ‘D’, ‘U’ or ‘F’ in a slot or symbol. For example, a resource type indication may be associated with a configured or an indicated SBFD UL and/or DL subband. An indication of the resource type may be provided independently of the transmission direction of a slot or symbol indicated to the UE by the TDD UL-DL frame configuration provided by higher layers.

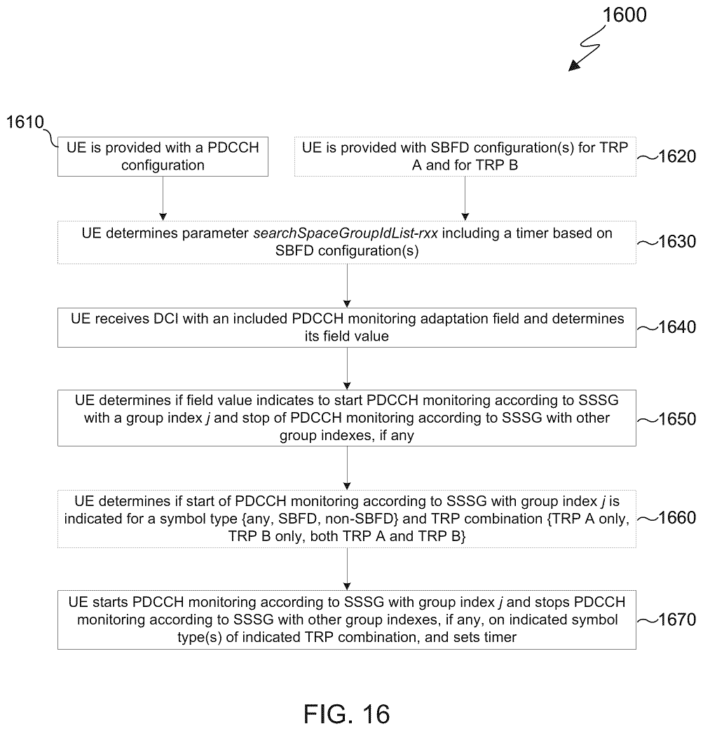

FIG. 16 illustrates a flowchart of an example process 1600 of SSSG switching for SBFD/non-SBFD symbol types based on provided SBFD configuration(s) per TRP in a FD communication system according to embodiments of the present disclosure. The process 1600 of FIG. 16 can be performed by any of the UEs 111-116 of FIG. 1, such as the UE 116 of FIG. 3. The process 1600 is for illustration only and other embodiments can be used without departing from the scope of the present disclosure.

The process 1600 begins with the UE being provided with PDCCH configuration (1610). The ULE is also provided with SBFD configurations for TRP A and TRP B (1620). The UE then determines a parameter searchSpaceGroupIdList-rxx based on the PDCCH configuration and based on the SBFD configurations for TRP A and TRP B (1630). The UE then receives a DCI with a PDCCH monitoring adaptation field and determines a field value (1640). The UE then determines if the field value indicates to start PDCCH monitoring according to SSSG with a group index j and stop of PDCCH monitoring according to SSSG with other group indexes, if any (1650). If the UE determines that SSSG switching is indicated by the field value, the UE further determines if start of PDCCH monitoring according to SSSG with group index j is indicated for one or a combination of symbol type {SBFD, non-SBFD} and for one or a combination of TRP for PDCCH receptions from {TRP A only, TRP B only, from TRP A and TRP B}(1660). The UE then starts PDCCH monitoring according to SSSG with group index j and stops PDCCH monitoring according to SSSG with other group indexes, if any, on indicated symbol types of the indicated TRPs, and sets a timer for the indicated symbol types and the indicated TRPs (1670).

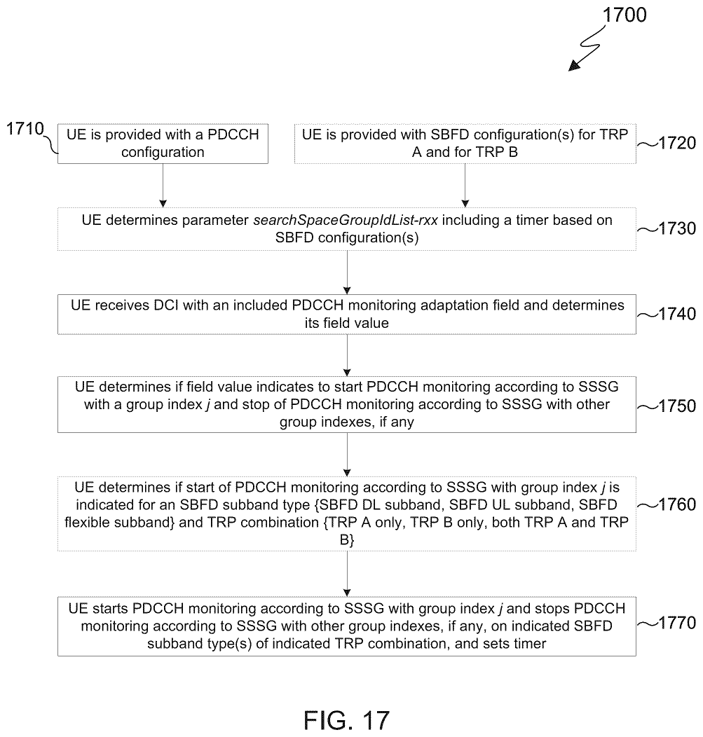

FIG. 17 illustrates a flowchart of an example process 1700 of SSSG switching for SBFD subband types based on provided SBFD configuration(s) per TRP in a full-duplex communication system according to embodiments of the present disclosure. The process 1700 of FIG. 17 can be performed by any of the UEs 111-116 of FIG. 1, such as the UE 116 of FIG. 3. The process 1700 is for illustration only and other embodiments can be used without departing from the scope of the present disclosure.

The process 1700 begins with the ULE being provided with PDCCH configuration (1710). The LIE is also provided with SBFD configurations for TRP A and TRP B (1720). The UE then determines a parameter searchSpaceGroupIdList-rxx based on the PDCCH configuration and based on the SBFD configurations for TRP A and TRP B (1730). The UE then receives a DCI that provide a PDCCH monitoring adaptation field and determines a field value (1740). The UE then determines if the field value indicates to start PDCCH monitoring according to SSSG with a group index j and stop of PDCCH monitoring according to SSSG with other group indexes, if any (1750). If the UE determines that SSSG switching is indicated by the field value, the UE further determines if start of PDCCH monitoring according to SSSG with group index j is indicated for one or a combination of SBFD subband type {SBFD DL subband, SBFD UL subband, SBFD flexible subband} and for one or a combination of TRP for PDCCH receptions from {TRP A only, TRP B only, from TRP A and TRP B} (1760). The UE then starts PDCCH monitoring according to SSSG with group index j and stops PDCCH monitoring according to SSSG with other group indexes, if any, on indicated SBFD subband types of the indicated TRPs, and sets a timer for the indicated SBFD subband types and the indicated TRPs (1770).

In one embodiment, a UE may be provided both PDCCHSkippingDurationList-rxx for PDCCH monitoring adaptation and searchSpaceGroupIdList-rxx for SSSG adaptation with respect to receptions from TRP A or from TRP B, or from TRP and TRP B. As described for PDCCH skipping or SSSG switching operation, an indication value for receptions from TRP A, or from TRP B, or from TRP A and TRP B, or on an SBFD subband may be provided to the UE by a unicast DCI such as DCI format 0_1/0_2/1_1/1_2, using an existing PDCCH monitoring adaptation field, or an extended PDCCH monitoring adaptation field that includes additional bits in case of SBFD operation, or an existing and a new PDCCH monitoring field, or two new PDCCH monitoring adaptation fields for operation in SBFD and non-SBFD time resources or SBFD subbands, to indicate PDCCH monitoring adaptation in slot/symbols or SBFD subbands where SBFD operation is supported from TRP A or from TRP B, or from TRP A and TRP B, or to indicate PDCCH monitoring adaptation in slot/symbols or SBFD subbands where SBFD is not supported with respect to receptions from TRP A or from TRP B, or from TRP A and TRP B when SBFD configurations are provided/indicated for TRP A and/or TRP B. A group-common DCI format, such as a DCI format 2_0 or 4_0 that a UE monitors associated PDCCH according to a common search space as described in [2] and [3], can also be used to provide an indication value to the UE for PDCCH monitoring adaptation with respect to receptions from TRP A or from TRP B or from TRP A and TRP B when SBFD configurations are provided/indicated for TRP A and/or TRP B.

For example, when a UE is provided by higher layers from a serving gNB a new parameter, for example PDCCHSkippingDurationList-rxx, that enables or disables PDCCH reception and/or a new parameter searchSpaceGroupIdList-rxx that assigns a SSSG for PDCCH monitoring for receptions from TRP A, or from TRP B, or from TRP A and TRP B, a codepoint in a DCI field of size N, e.g., N=4 bits, can indicate whether a first CORESET and a second CORESET (or a first SSSG and a second SSSG) are linked or not linked for a time duration. For example, a codepoint can indicate one or more or a combination of the following:
if the CORESETs (or SSSGs) are linked or not linked on SBFD symbols;
if the CORESETs (or SSSGs) are linked or not linked on non-SBFD symbols;
if the CORESETs (or SSSGs) are linked or not linked on both non-SBFD and SBFD symbols;
if the CORESETs (or SSSGs) are linked or not linked based on a SBFD configuration;
if the CORESETs (or SSSGs) are linked or not linked based on an SBFD subband or subband type;
if the CORESETs (or SSSGs) are linked or not linked based on a first event or condition with respect to TRP A and/or a second event or condition with respect to TRP B wherein an event or a condition can be a symbol type or an SBFD configuration or an SBFD subband type.

For example, an indication value associated with a PDCCH monitoring adaptation for receptions from TRP A or from TRP B, or from TRP A and TRP B in non-SBFD and SBFD symbols or on SBFD subbands of TRP A, or TRP B, or TRP A and TRP B, may be provided to the UE by a DCI using an existing PDCCH monitoring adaptation field with size of 1 or 2 bits, or an extended field with size of 2 or 4 bits, or both an existing and a new field, or two new fields corresponding to SBFD and non-SBFD time resources or SBFD subbands, with jointly or separately configured sizes, where a size of 0 bits represents the case that the field is not configured by the gNB for the UE, and using PDCCHSkippingDurationList-rxx or searchSpaceGroupIdList-rxx.

When a UE is provided both PDCCHSkippingDurationList-rxx and searchSpaceGroupIdList-rxx, a mapping of a PDCCH monitoring adaptation field for receptions from TRP A, or from TRP B, or from TRP A and TRP B on non-SBFD/SBFD symbols or an SBFD subband can be such that some values indicate a duration for PDCCH skipping and some values indicate a new SSSG with respect to receptions from TRP A or from TRP B, or from TRP A and TRP B. As for only PDCCH skipping or only SSSG switching, the UE may also be provided existing PDCCHSkippingDurationList and searchSpaceGroupIdList and in such case PDCCH skipping or SSSG switching with respect to receptions from TRP A or from TRP B, or from TRP A and TRP B, can be separately indicated for non-SBFD slots or symbols or SBFD subbands by a value of a first field in the DCI format indicating an entry from PDCCHSkippingDurationList or from searchSpaceGroupIdList for SBFD slots or symbols or SBFD subbands, and by a value of a second field in the DCI format indicating an entry from PDCCHSkippingDurationList-rxx or from searchSpaceGroupIdList-rxx, or depending on a type of slot/symbols where the UE receives the PDCCH providing the DCI format. The first and second fields can be same or different.

In case the first and second fields in a DCI are a same field and in a first approach, a same value can apply to determine an entry from PDCCHSkippingDurationList or searchSpaceGroupIdList, or from PDCCHSkippingDurationList-rxx or searchSpaceGroupIdList-rxx in case these parameters are applicable to all symbol/slot/subband types for receptions from TRP A or from TRP B or from TRP A and TRP B, that is applicable to non-SBFD slots or symbols or subbands, and an entry from PDCCHSkippingDurationList-rxx or searchSpaceGroupIdList-rxx that is applicable to SBFD slots or symbols or an SBFD subband for TRP A or for TRP B. Alternatively, the value may be applicable only to slots/symbols of a same type as the slot/symbols of the PDCCH reception with the DCI.

In case the first and second fields are a same field and in a second approach, first bits of the field provide a first value to determine an entry from PDCCHSkippingDurationList or searchSpaceGroupIdList, or from PDCCHSkippingDurationList-rxx or searchSpaceGroupIdList-rxx in case these parameters are applicable to all symbol/slot/subband types of TRP A or TRP B, that is applicable to non-SBFD slots or symbols or an SBFD subband and second bits from the field provide a second value to determine an entry from PDCCHSkippingDurationList-rxx or searchSpaceGroupIdList-rxx that is applicable to SBFD slots or symbols or an SBFD subband.

In case the first and second fields are different, a first value of the first field indicates an entry from PDCCHSkippingDurationList or searchSpaceGroupIdList, or from PDCCHSkippingDurationList-rxx or searchSpaceGroupIdList-rxx in case these parameters are applicable to all symbol/slot/SBFD subband types of TRP A or TRP B, that is applicable to non-SBFD slots or symbols or subbands, and a second value of the second field indicates an entry from PDCCHSkippingDurationList-rxx or searchSpaceGroupIdList-rxx that is applicable to SBFD slots or symbols or an SBFD subband of TRP A or TRP B.

Similar to the embodiments for indicating only PDCCH monitoring skipping durations or indicating SSSGs for combinations of {SBFD, non-SBFD} resources and of {TRP A, TRP B}, the DCI format can include two fields; a first indicating a PDCCH monitoring skipping duration or an SSSG on SBFD resources for both TRP A and TRP B, and a second indicating a PDCCH monitoring skipping duration or an SSSG on non-SBFD resources for both TRP A and TRP B. It is also possible that a DCI format includes four fields; a first indicating a PDCCH monitoring skipping duration or an SSSG on SBFD resources for TRP A, a second indicating a PDCCH monitoring skipping duration or an SSSG on non-SBFD resources for TRP A, a third indicating a PDCCH monitoring skipping duration or an SSSG on SBFD resources for TRP B, and a fourth indicating a PDCCH monitoring skipping duration or an SSSG on non-SBFD resources for TRP B.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method for a user equipment (UE) to receive physical downlink control channels (PDCCHs), the method comprising:
receiving (i) a first set of parameters for reception of first PDCCHs associated with a first subset of slots from a set of slots and (ii) a first transmission configuration indicator (TCI) state configuration on a cell;
receiving (i) a second set of parameters for reception of second PDCCHs associated with a second subset of slots from the set of slots and (ii) a second TCI state configuration on the cell;
receiving a first PDCCH from the first PDCCHs that provides a downlink control information (DCI) format, wherein the DCI format includes a field indicating skipping receptions of the second PDCCHs; and
skipping, based on the field, receptions of the second PDCCHs in a slot from the second subset of slots at a first occasion that is after reception of the first PDCCH and before an end of a time duration,
wherein the first subset of slots does not include time-domain resources indicated for simultaneous transmission and reception on the cell, and
wherein the second subset of slots includes time-domain resources indicated for simultaneous transmission and reception on the cell.

2. The method of claim 1, wherein:
a first TCI state code point from the first TCI state configuration or a second TCI state code point from the second TCI state configuration includes:
a downlink (DL) TCI state,
an uplink (UL) TCI state,
a joint TCI state, or
a pair of DL TCI state and UL TCI state;
a TCI state includes a source reference signal for quasi-colocation or for spatial information;
if the TCI state is associated with the first TCI state code point, the source reference signal is transmitted in the first subset of slots or symbols; and
if the TCI state is associated with the second TCI state code point, the source reference signal is transmitted the second subset of slots or symbols.

3. The method of claim 1, further comprising receiving the second PDCCHs in a slot from the second subset of slots at a second occasion that is after the end of the time duration.

4. The method of claim 1, wherein:
skipping receptions of the second PDCCHs further comprises skipping receptions of the second PDCCHs based on a slot or symbol type; and
the slot or symbol type is a downlink (DL) or flexible (F) slot or symbol.

5. The method of claim 1, wherein:
the field corresponds to an extended PDCCH monitoring adaptation field,
the time duration associated with the skipping of receptions of the second PDCCHs is provided by a first radio resource control (RRC) parameter, and
another time duration associated with skipping of receptions of the first PDCCHs is provided by a second RRC parameter.

6. The method of claim 1, wherein:
skipping receptions of the second PDCCHs further comprises skipping receptions of the second PDCCHs based on a subband full-duplex (SBFD) subband type; and
the SBFD subband type is a first DL subband, a second DL subband, a flexible (F) subband, or an uplink (UL) subband.

7. The method of claim 1, wherein:
the time duration is a second time duration,
the field comprises first bits and second bits,
the first bits indicate a first time duration associated with skipping of receptions of the first PDCCHs, and
the second bits indicate the second time duration associated with skipping of receptions of the second PDCCHs.

8. A user equipment (UE), comprising:
a transceiver configured to:
receive (i) a first set of parameters for reception of first physical downlink control channels (PDCCHs) associated with a first subset of slots from a set of slots and (ii) a first transmission configuration indicator (TCI) state configuration on a cell;
receive (i) a second set of parameters for reception of second PDCCHs associated with a second subset of slots from the set of slots and (ii) a second TCI state configuration on the cell; and
receive a first PDCCH from the first PDCCHs that provides a downlink control information (DCI) format, wherein the DCI format includes a field indicating skipping receptions of the second PDCCHs; and
a processor operably coupled to the transceiver, the processor configured to determine to skip, based on the field, receptions of the second PDCCHs in a slot from the second subset of slots at a first occasion that is after reception of the first PDCCH and before an end of a time duration,
wherein the first subset of slots does not include time-domain resources indicated for simultaneous transmission and reception on the cell, and
wherein the second subset of slots includes time-domain resources indicated for simultaneous transmission and reception on the cell.

9. The UE of claim 8, wherein:
a first TCI state code point from the first TCI state configuration or a second TCI state code point from the second TCI state configuration includes:
a downlink (DL) TCI state,
an uplink (UL) TCI state,
a joint TCI state, or
a pair of DL TCI state and UL TCI state;
a TCI state includes a source reference signal for quasi-colocation or for spatial information;
if the TCI state is associated with the first TCI state code point, the source reference signal is transmitted in the first subset of slots or symbols; and
if the TCI state is associated with the second TCI state code point, the source reference signal is transmitted the second subset of slots or symbols.

10. The UE of claim 8, wherein the transceiver is further configured to receive the second PDCCHs in a slot from the second subset of slots at a second occasion that is after the end of the time duration.

11. The UE of claim 8, wherein:
the processor is further configured to determine to skip receptions of the second PDCCHs based on a slot or symbol type; and
the slot or symbol type is a downlink (DL) or flexible (F) slot or symbol.

12. The UE of claim 8, wherein:
the field corresponds to an extended PDCCH monitoring adaptation field,
the time duration associated with the skipping of receptions of the second PDCCHs is provided by a first radio resource control (RRC) parameter, and
another time duration associated with skipping of receptions of the first PDCCHs is provided by a second RRC parameter.

13. The UE of claim 8, wherein:
the processor is further configured to determine to skip receptions of the second PDCCHs based on a subband full-duplex (SBFD) subband type; and
the SBFD subband type is a first DL subband, a second DL subband, a flexible (F) subband, or an uplink (UL) subband.

14. The UE of claim 8, wherein:
the time duration is a second time duration,
the field comprises first bits and second bits,
the first bits indicate a first time duration associated with skipping of receptions of the first PDCCHs, and
the second bits indicate the second time duration associated with skipping of receptions of the second PDCCHs.

15. A base station (BS), comprising:
a processor; and
a transceiver operably coupled to the processor, the transceiver configured to:
transmit (i) a first set of parameters for reception of first physical downlink control channels (PDCCHs) associated with a first subset of slots from a set of slots and (ii) a first transmission configuration indicator (TCI) state configuration on a cell;
transmit (i) a second set of parameters for reception of second PDCCHs associated with a second subset of slots from the set of slots and (ii) a second TCI state configuration on the cell; and
transmit a first PDCCH from the first PDCCHs that provides a downlink control information (DCI) format, wherein the DCI format includes a field indicating skipping receptions of the second PDCCHs in a slot from the second subset of slots at a first occasion that is after transmission of the first PDCCH and before an end of a time duration,
wherein the first subset of slots does not include time-domain resources indicated for simultaneous transmission and reception on the cell, and
wherein the second subset of slots includes time-domain resources indicated for simultaneous transmission and reception on the cell.

16. The BS of claim 15, wherein:
a first TCI state code point from the first TCI state configuration or a second TCI state code point from the second TCI state configuration includes:
a downlink (DL) TCI state,
an uplink (UL) TCI state,
a joint TCI state, or
a pair of DL TCI state and UL TCI state;
a TCI state includes a source reference signal for quasi-colocation or for spatial information;
if the TCI state is associated with the first TCI state code point, the source reference signal is transmitted in the first subset of slots or symbols; and
if the TCI state is associated with the second TCI state code point, the source reference signal is transmitted the second subset of slots or symbols.

17. The BS of claim 15, wherein the transceiver is further configured to transmit the second PDCCHs for reception in a slot from the second subset of slots at a second occasion that is after the end of the time duration.

18. The BS of claim 15, wherein:
receptions of the second PDCCHs are further indicated to be skipped based on a slot or symbol type; and
the slot or symbol type is a downlink (DL) or flexible (F) slot or symbol.

19. The BS of claim 15, wherein:
the field corresponds to an extended PDCCH monitoring adaptation field,
the time duration associated with the skipping of receptions of the second PDCCHs is provided by a first radio resource control (RRC) parameter, and
another time duration associated with skipping of receptions of the first PDCCHs is provided by a second RRC parameter.

20. The BS of claim 15, wherein:
receptions of the second PDCCHs are further indicated to be skipped based on a subband full-duplex (SBFD) subband type; and
the SBFD subband type is a first DL subband, a second DL subband, a flexible (F) subband, or an uplink (UL) subband.
